(19) United States
(12) Patent Application Publication
(10) Pub. No.: US 2025/0091285 A1
(43) Pub. Date: Mar. 20, 2025

(54) DIGITALLY-CONTROLLED WALL-BUILDING SYSTEMS HAVING AN IMPROVED CONSTRUCTION SEQUENCE

(71) Applicant: Michael George BUTLER, Fort Bragg, CA (US)

(72) Inventor: Michael George BUTLER, Fort Bragg, CA (US)

(21) Appl. No.: 18/729,488

(22) PCT Filed: Jan. 16, 2023
(86) PCT No.: PCT/US2023/010876

§ 371 Date: Jul. 16, 2024

Related U.S. Application Data
(60) Provisional application No. 63/300,048, filed on Jan. 16, 2022.

(51) Int. Cl. B29C 64/106; B29C 64/194; B33Y 10/00; B33Y 80/00

(52) U.S. Cl. CPC B29C 64/106; B29C 64/194; B33Y 10/00; B33Y 80/00

(57) ABSTRACT

An aspect that includes a method for constructing a wall. The method includes placing a plane of insulation (1) at the location for the wall. Applying a layer of cladding (2) on a side of the plane of insulation (1). The method further includes forming a concrete wall structure (3) on an opposite side of the plane of insulation (1) such as by in situ placing a cementitious material against the plane of insulation (1). Another aspect includes an apparatus for constructing a wall. A third aspect includes a system for constructing a wall. A fourth aspect includes an admixture composition.

### CROSS-REFERENCE TO RELATED APPLICATIONS

The present application is a National Stage entry from PCT Application PCT/US23/10876, filed Jan. 16, 2023, which claims benefit of U.S. Provisional Patent application Ser. No. 63/300,048, entitled “DIGITALLY-CONTROLLED WALL-BUILDING SYSTEMS AND METHODS,” to Michael George BUTLER, filed Jan. 16, 2022. The present application is related to U.S. Patent Application Ser. No. 62/446,444, titled “Methods and Devices to Make Zero-Slump-Pumpable Concrete,” to Michael George BUTLER, filed Jan. 15, 2017 and “APPARATUSES AND SYSTEMS FOR AND METHODS OF GENERATING AND PLACING ZERO-SLUMP-PUMPABLE CONCRETE”, to Michael George BUTLER, filed Jan. 16, 2018; and U.S. Patent Application Ser. 62/793,868, titled “ADDITIVE LAYERING SYSTEMS FOR CAST-CONCRETE WALLS” to Michael George BUTLER, filed Jan. 19, 2019; and U.S. Patent Application Ser. No. 62/830,445, titled “APPARATI TO COMPENSATE FLOW VARIATIONS OF A PISTON PUMP, PARTICULARLY ALLOWING CONSTANT RATE ROBOTIC PLACEMENT OF CONCRETE”, to Michael George BUTLER, U.S. Patent Application Ser. 62/834,923, titled “VERY RAPID CONCRETE SLIP FORMING OVER EXTENSIVE VERTICAL SURFACES WITH REMOTELY CONTROLLED AND AUTOMATED SYSTEMS” to Michael George BUTLER, filed Apr. 16, 2019; and U.S. Patent Application Ser. No. 63/286,091, titled “VISCOSITY CONTROL SYSTEMS FOR IMPROVED CONCRETE OR MORTAR EXTRUSION” to Michael George BUTLER, filed Dec. 5, 2021 and U.S. Patent Application Ser. No. 63/338,032, “RAPIDLY-DEPLOYABLE AUTOMATED WALL-CONCRETE PLACEMENT SYSTEM,” to Michael George BUTLER, filed 04-May-2022. The contents of all of these applications and patents are incorporated herein in their entirety by this reference for all purposes.

### BACKGROUND

One or more aspects of the present invention pertain to the technical field of construction. More specifically, one or more aspects of the present invention pertain to the field digitally-controlled placement of cementitious materials, and also of foaming materials; more particularly, the 3D printing or vertical slip-forming of buildings and other structures with a concrete or mortar material, after foam insulation is placed.

### SUMMARY

The ideally optimized dwelling wall assembly for a cold or partially-cold climate, will emphasize insulation and avoiding thermal bridging, while providing appropriate thermal mass. It will include all necessary moisture control, so avoiding inceptions to condensation, decay and mold. A preferred wall would also be fire, hurricane, and earthquake resistant, and meet necessary building codes. Other existing digitally-controlled wall construction means do not provide these characteristics. The present invention provides all of these benefits, and at a lower finished cost, because this method allows all new construction processes to be performed in an improved and more-efficient sequence, and also to a more completed state.

Conventional framed-wall construction allows for too much thermal bridging at framing members, and imperfections in continuity of the building shell. Also, it is of a material that infests, rots, and burns. Better quality construction has framed walls that are also wrapped with foam panels, in order to provide sufficient insulation. So the question is: If one is going to provide that foam, with fireproof cladding on the outside, and thermal mass in the inside, then why also build all the wood framing that is no longer necessary?

Insulated Concrete Form (ICF) wall construction, and the like, can avoid thermal bridging in that stay-in-place wall forms of foam insulation can be continuous on both sides of a concrete wall placement. Though these methods suffer disadvantages in normally requiring foam insulation on both sides of the wall's concrete thermal mass, because the insulation between conditioned space and thermal mass is thermally counterproductive, and then must subsequently be clad over with non-flammable gypsum board or the like. These systems could be twice as thermally efficient if all of the foam were to be placed on the exterior side of the thermal mass, and none on the interior side—where the concrete mass can also serve as the finished interior surface, such as with the present invention. This point is evidenced by the introduction of modified ICF systems having one side removable, so that the solid concrete surface can be presented for purposes of fire rating, hurricane impact resistance, and improved thermal performance; all of these are accomplished with the present invention, but without the need of form ties, to deal with form pressure, and to remove a forming surface.

A major flaw with wall assemblies of 3D-printed of cementitious material is that necessary moisture control barriers or other measures are effectively impossible to implement between the wythes of 3D-printed mortar and the interior insulation space, and that significant thermal bridging can be present between the wythes-such as where solid concrete fill is needed for structure or code compliance. Condensation is probable, leading to more heat loss, and probably mold, in cold/wet climates. Most 3D-printed projects to date have also required additional subsequently-poured reinforced-concrete walls, at many locations between wythes, in order to meet structural requirements. These resulting walls of solid reinforced concrete (being an efficient heat conductor) is excessively inefficient thermally. For this reason, recent projects in northern Europe have required 3 wythes to be digitally constructed in order to meet both insulation and structural requirements, resulting in walls approaching a half-meter in thickness. This is too expensive. However, the other option is suffering with poor insulation.

Another problem is that 3D-printed buildings do not meet building code requirements, such as those of the International Residential Code, which is a subset of the International Building Code (the code generally referred to herein), so that insurers will then not insure the building, and therefore lenders will not provide a mortgage. These positions are understandable, in that the robotic methods used so far require that the result is different in some detrimental ways. For example, 3D printed walls that cannot have conventional reinforcing, then they cannot necessarily be relied upon structurally, and so the building may not be mortgageable; or it is necessary to subsequently place conventional reinforced concrete-creating both higher cost and lower wall insulation value. As the anchorage of roofs to the unreinforced walls is non-compliant with known anchorage practices, it is unknown how well the roof will stay attached during high wind events. As 3D printed interlayer bonding can be variable (by observation), and there is no reliable way to provide a water barrier, it is unknown how seriously the long-term water intrusion may become a problem for occupants. But, what if digitally-controlled construction did not have to have any of these drawbacks?

If the insulation plane can be created first, this provides the opportunity to place wall concrete from the side, thereby allowing preplacement of reinforcing elements-so that the wall structure can meet structural design requirements and existing building codes, and the amount of concrete structurally required can be reduced and can be of a much less expensive common concrete, rather than a specialized 3D-print mortar. And, concrete placement from the side allows preplacement of door and window opening frame elements, as well as needed utility elements, and structural attachments-such as roof or floor anchorage elements, that need to be cast into, or placed behind, the structural concrete; and this allows a sequence where the next-floor or roof framing, or at least portions of it, can be utilized as a means to physically position and/or define the wall plane, before concrete is placed, as the concrete placement from the side can occur right up to the bottom of that framing-now also acting as a brace. Also, the subsequent installation processes, such as window, door, and roof installations are facilitated, because the result of this process is more accurate at those connecting boundaries, and the digitally-fabricated surfaces are smooth, precise, and referenced to designed door/window frame locations, precisely located with use of embedded RFID tag information, or the like, sent to the digitally-controlled concrete placement system, to indicate where wall openings are, etc. These can be combined with barcodes, so that the robots can identify retrieve a particular window frame, and then attach to it, know where it goes, and move the frame into position, then hold it there as another robot foams the window frame into place.

As the robots can preferably be equipped with RFID readers for this purpose, including positional information gathering, the workers in the area can also have specific “personnel” RFID tags on their person, such as sewn onto required safety vests, so the robots can avoid contact with people working in the same area, so avoiding human/robot interaction safety hazards.

As the preplaced frames or “bucks” for wall openings can be used to define the plane of finished wall surfaces, and can be made to also serve as pre-situated integral waterproofing, weatherproofing, and flashing barriers, so these extensive labor costs after concrete placement can now be avoided. Elements that necessarily define edge and opening boundaries of a wall for purposes of operable mechanisms, such as windows, or other dimensionally-precise premanufactured structures, such as roof trusses, if preplaced precisely, facilitate those subsequent installations, and also define exactly where the finished wall concrete surface needs to be located for those installations. This is a much more productive and efficient sequence, now possible, because completion of the machine-controlled process results in a more-completed and more-finished state of construction. Compared to conventional sequence of 3D-printing walls, the follow-up labor and other finishing costs are reduced drastically, and the resulting construction is far superior in thermal, moisture control, structural performance, and lower cost.

An essential element to making this improved wall construction sequence possible is the powerfully-modifying admixture composition that allows for rapid vertical build of conventional concrete. This is because the new sequence requires a placement process where the consolidation fluid pressure can be localized and minimized in scale, to lower overall pressure load placed against the foam; and where the footprint of a given placement-lift operation is preferably much smaller than the building footprint, allowing smaller lighter robots to place concrete, and allow establishment of control joints to prevent shrinkage cracking

The ideal wall assembly is of digitally controlled layers, with each having an ideal thickness, strength, and insulation value, according to its necessary function. No less, no more. Present methods employed for 3D printing cannot economically do this, so it is not done. Instead, a 2 inch (50 mm) thick wythe is printed all around, for wall interiors, exteriors, openings, wythes in between, and anything else. This is a compromise thickness, that is not enough to be a structural wall, but twice as much as is needed for cladding and wildfire-proofing. And by codes, if an outer layer that is 2 inches thick, then requires a 1-inch air gap behind it for moisture dissipation, which present 3D-print methods cannot really accommodate (unless the entire void between wythes is left uninsulated). The cladding layer should prevent intrusion of liquid water, while release any accumulated water vapor to the exterior. Horizontal and vertical support of cladding needs be provided according to building code requirements. 3D printed wythes then cannot be cladding according to code definition.

The concept of slip forming foam to create an insulating plane is not limited to walls; as foam is light and can also be very rigid, this method of using digitally-controlled slip-forming of foam in-situ can also be applied to roof, ceiling, and floor construction.

And a structural concrete wall (load bearing, lateral-force resisting) should be sufficiently thick for its necessary purposes, most efficiently serving as building structure and thermal mass, and so preferably being thermally isolated from the exterior. Present 3D printing methods do not allow for preplacement of reinforcing elements, except in a very limited fashion for only horizontal members, so the printed concrete or mortar by itself cannot meet building codes. And present methods create the inner and outer wythes of the same width, so that the “structural” wythe is too narrow and does not meet codes, while the outer wythe is generally more than twice the width required for cladding, so consuming twice the amount of an unnecessarily expensive material. The present invention solves all of these problems present in contemporary 3D-printed wall assemblies.

And insulation—the most important part of the wall—should be of the best appropriately-available material, in order to improve occupant comfort and reduce the required wall thickness; and it should cover every square millimeter of exterior walls; without interruption and without thermal bridging, as is possible. The best sequence to accomplish this is to place the insulation first, so allowing access to install proper water barriers, or other moisture controls, onto it, before printing concrete layers aside it (then closing off that access). The present invention provides all of these design improvement benefits, as much as is possible to do with any construction method, and does this by use of an in-situ automated process, which also completes walls to a much more finished state than any other digital construction process can do.

Another advantage of the present invention is in providing a preferred novel sequence in that the initial material placement of foam is extruded, or more accurately, “slip-formed”, in vertically in adjacent placements. “Extrude” is forcing through a die under high pressure, whereas “slip-form” is distinguishing term to mean continuously formed as if extruded, but without the “forcing” or high pressure. Slip-forming is more sensitive to friction or adhesion, because the force may just be the material weight, or a relatively small amount of applied force-one that does not collapse the foaming action. This slip forming vertically in multiple adjacent paths, or sequential-adjacent vertical slip-forming process, will intersect locations of windows and doors sequentially, whereas a horizontal placement will intersect door and window locations simultaneously. Intersecting these locations sequentially, rather than simultaneously, can be crucially important, in that it allows for interactive placement of frames (“bucks” or jambs) for these wall openings with another automated device. So, a buck-placing robot can hold a window buck in position, while a foam placement robot can place foam around the buck, locking it into position, while the buck placement robot retrieves the next buck in sequence. This type of interactive process is simply impractical with initial horizontal layering of wall material, as an impractically-large number of buck placement robots would be required for that necessarily-simultaneous buck positioning. Machine-controlled extrusion or “printing” the geometry of a rapidly-setting, lightweight material, such as spray urethane foam, allows vertical-motion extrusion—in fact it works better in having gravity to assist in keeping freshly placed foam intact as extrusion proceeds. The convention of horizontal layering of 3D-print filaments, as all other foam-printing processes have been before this, is obsolete for this type of material.

This slip-forming of urethane foam, now possible with the new active non-stick surface, is not limited to walls or buildings, it can apply to any need of a urethane foam to be “extruded” into a particular shape, such as cylinders or half-cylinders for pipe jacketing in very cold climates.

The structure for this wall assembly is concrete placed by machine control, in lieu of conventional 3D-printing, building forms, or spraying shotcrete. In the preferred sequence, the concrete is placed after the rigid foam insulation, for reasons noted above. The in-place foam does not have to be printed, slip-formed, or extruded, it can be of rigid foam panels erected into place. Digitally-controlled cutting equipment can create the wall window openings, et cetera, in the proper locations in those panels, such as using a hot-knife to slice EPS foam, either before or after erecting the foam panels. This alternative to in-situ extrusion of foam is interchangeable with the rest of the processes disclosed herein.

For any embodiment, the concrete must have sufficient vertical buildability, and in order to make practical use of low-cost delivered ready-mix concrete, this rate of vertical build of the cementitious material placed against the foam plane by an additive layering (additive manufacturing) process, must be at a greater rate than existing, more expensive, 3D-print mortars will allow. By cementitious material, mortar or concrete, what is meant is any hydraulically-setting binder, combined with an aggregate of some type.

The solution allowing rapid vertical build of a cementitious material, is inline modification, as disclosed previously by the present inventor. The presently-disclosed improvement to the process is an improved modifying admixture, that allows greater rheology modification at lower dose, and avoids inclusion of detrimental components. This highly effective material modification is necessary for a cost effective implementation of the improved sequence, in that the vertical build of the concrete placement would otherwise require too much time, particularly with the preferred method, a series of wall placements from vertical control joint to vertical control joint. For efficiency, the concrete placement should be able to keep up as possible with the foam placement rate, and also should be fast enough to make practical use of delivered, low-cost, ready-mix concrete. The modifying admixture composition concept, being a liquid carrier that is non-reactive, or not significantly reactive, to water-reactive solids that are suspended in it, the combination capable of providing a very high concentration of water-reactive solids in a liquid, to change the rheology of concrete. This is an essential process in allowing this new construction sequence—additive layering of concrete after foam placement—to succeed as a significant improvement in construction practice. This admixture concept can speed up slip forming processes, allowing taller and smaller-footprint projects, such as the ever-growing wind-turbine towers, that now become viable to build in-situ, because of the faster and more efficient slip forming than was ever possible before.

The concept of a non-water liquid carrier facilitates introduction of water-reactive shrinkage compensators. It also provides a means for a practical recreation of the more durable “Roman concrete”, but in large placements, at higher production rate, using contemporary equipment. The Roman concrete is well suited to placement without forms or 3D printing (additive manufacturing). The present method allows the quicklime of Roman concrete, or powdered shrinkage compensators, to be easily introduced into concrete without adding extra water.

### BRIEF DESCRIPTION OF THE DRAWINGS

FIG. 1 shows an ideal wall assembly.

FIG. 2 shows sequential processes that create the wall assembly.

FIGS. 3A and 3B show a foam slip-forming device.

FIGS. 4 and 5 show a foam slip-forming device that implants wall tie elements.

FIG. 6 show a foam slip-forming device with a foam pusher.

FIG. 7 shows a device that inserts wall tie elements.

FIG. 8 shows additional embodiments of the sequential processes and including wall edge conditions.

FIG. 9 shows section views of a vertical placement device.

FIG. 10 shows a vertical-axis control system for a vertical placement device with a wall brace mechanism.

FIG. 11 shows a section view of a vertical-axis control system for a vertical placement device with a wall brace mechanism.

FIG. 12 shows layers of vertically placed concrete.

FIG. 13 shows views of a vertical placement device with adjustable width restriction.

FIG. 14 shows a downward-view-section of a crab nozzle.

FIG. 15 shows a section of a wall with a furring tie in place.

FIG. 16 shows a precise-fit frame for a window, before installation.

FIG. 17A shows a section of a lintel member of a precise-fit frame at construction completion.

FIG. 17B shows a section of a sill member of a precise-fit frame at construction completion.

FIG. 18 shows a frame setter that is installing a precise-fit frame into a foam wall.

FIG. 19 shows a construction process in the new sequence accomplished by cooperating robots.

FIG. 20 shows a graph of the apparent set and acceleration of apparent set of mortar mixtures.

FIG. 21 shows proportional shrinkage of mortar mixes under controlled conditions.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. Reference numerals are meant to be interchangeable between drawing figures, so that a reference numeral not referred to in a given figure description will be described elsewhere.

### DESCRIPTION

Various embodiments of the present invention may include any of the described features, alone or in combination. Other features and/or benefits of this disclosure will be apparent from the following description. The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

The various elements of any of these devices disclosed herein can advantageously be combined with other devices in many different permutations. Generally, for the present disclosure, only a single example of each feature is given, and any of the other combinations of the features is not also shown, as it is typically apparent that these other combinations of the features can be made by persons of ordinary skill in the art in view of the present specification.

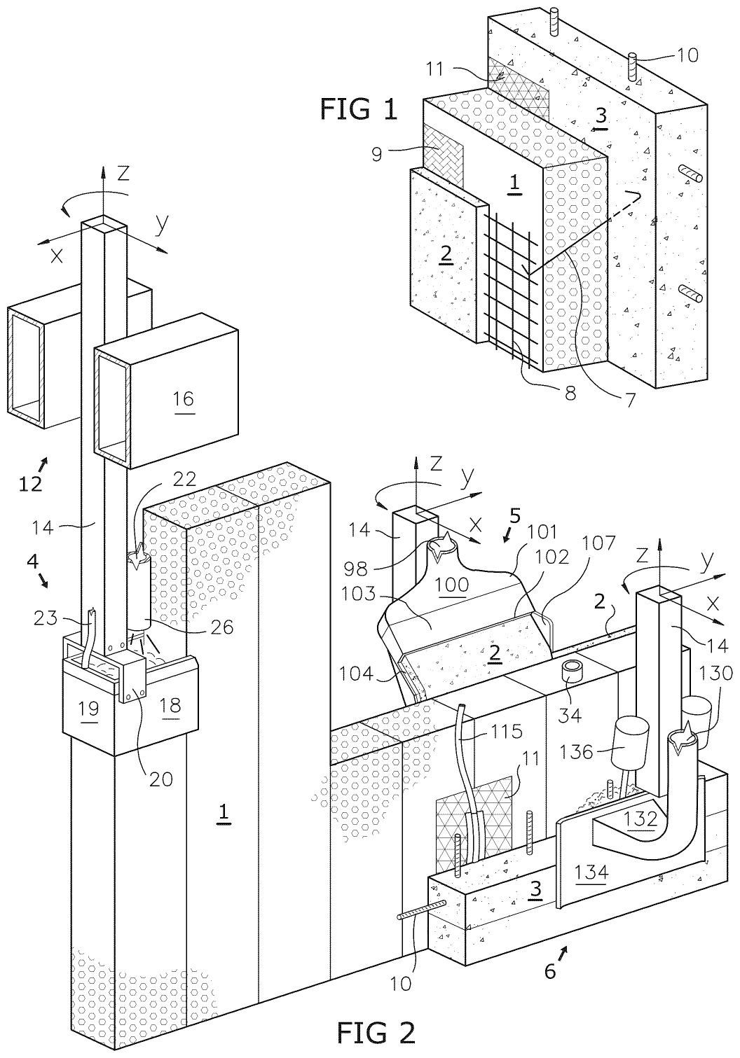

### FIG. 1

This shows the 3 essential parts of an insulated wall assembly: insulation, cladding, structure. These are numbered according to this new, more efficient, and more beneficial sequence of construction. This sequence can start with a plane of insulation 1, then with a layer of cladding 2, and finally a concrete wall structure 3; or the sequence can start with the plane of insulation 1, then the concrete wall structure 3, and then a layer of cladding. To be clear, other steps occur within these material placements, such as installation of utilities and frames for wall openings, etc. One will see how this construction sequence, opening frames and utilities before concrete placement, improves the efficiency for all of these attendant processes. These sequences, novel for digitally-controlled wall construction, in allowing the plane of insulation to be placed before wall structure, are preferable in many ways; including the ability to provide interlayer membranes, in that the placed-foam-first surfaces are accessible for coating purposes, compared to other digital sequences of construction that do not allow sufficient access to inter-surfaces for placement of membranes. So, if necessary or preferable, a vapor permeable waterproofing layer 9 can be placed behind the cladding 2, and a vapor impermeable waterproofing layer 11 can be placed between the insulation 1 and the concrete structure 3 (It is commonly applied as a liquid membrane to the foam 1). The need for these additional layers, and their preferred properties, is dependent upon factors such as: the insulation material, the conditions at hand, and the site climate.

The plane of insulation 1 can also be made of a contiguous series of premanufactured panels of rigid insulation erected into position, or it can be of a cementitious insulation material, such as “aircrete” 3d-printed in situ, or of any other sufficiently-rigid insulation material, or substrate, placed by any means-even a physical placement of rigid foam panels. As a primary embodiment disclosed is that of using a fluid expanding-foam agent material, to slip-form sprayed foam in place (in-situ), by digitally-controlled means, reference 1 is often referred to just as “foam” or “foam wall.” That is, the foaming agent is metered into, and then expands into, a confined space that is a slip form. The confined space can continually move, or move in discrete steps or lifts, at a rate that is in coordination with a controlled volume of supplied fluid foaming agent, so “slip forming” a plane of foam in-situ, the plane having relatively flat surfaces. The determination of the amount of expanding foam agent to be metered for each lift, is done by the foam manufacturer's literature and trial and error.

A most important advantage to this digital construction sequence is that it allows pre-placement of reinforcing elements in vertical planes, something considered to be the holy grail of 3D-printed concrete or mortar—not possible until now. This is, at present writing, the only way to allow such 3D printed walls to meet building code reinforcing requirements. That is, where a plane is put in position first, so that the layered placement of concrete can be made from the side—allowing pre-positioned reinforcing elements to already be in place, and pre-positioned vertical reinforcing in general, without causing interference with the additive layering placement of concrete. In this case, the prepositioned plane is a plane of insulation that is needed anyway, and it is better to position it before concrete for many other reasons. Such as, this sequence allows digitally-controlled placement of thinner planes of cementitious material, so that an economical cladding can be utilized. Another advantage is that it facilitates the vibrating of layered concrete into place, so improving material consolidation, particularly about reinforcing elements, and improved interlayer bonding.

So, if desired, a reinforcing mesh 8 can be preplaced before application of a plaster or stucco cladding, as is presently required by building codes for stucco cladding. Mesh can be galvanized hardware cloth, stucco wire, furred stucco mesh, fiberglass, basalt, etc. And if required, a number of a reinforcing element 10, also known as rebar, can be prepositioned before placement of concrete, as is presently required by building codes. These elements of rebar can be substituted with mesh panels. Robotic placement means of these reinforcing elements is not disclosed here, but such methods have been initiated by others; and some in conjunction with the 3D printing process, for horizontal reinforcing elements. Any such new or traditional methods are compatible with the processes disclosed. Of course, the inclusion of fiber mesh elements within printed material can reduce or eliminate the need for prepositioned reinforcing elements in some circumstances, and allow this process to be entirely robotic. Or, the digitally-controlled placement of reinforcing elements can also allow this method to be entirely robotic.

A series of a wall tie 7 is necessary to maintain attachment of cladding 2 to the structure 3. The tie has one end cast into the cladding and the other end cast into the concrete. Tie can be of galvanized steel wire, but is preferably of stainless steel (having more strength and half the thermal conductivity), or of composite material such as fiberglass, basalt, Kevlar, etc., because of having negligible thermal transfer. Ties generally have a hooked end that extends mostly into the plaster or stucco layer 2, and sufficiently into the concrete 3. Ties and their hooks are more thoroughly discussed further on.

Building codes require cladding to have connections that provide vertical support as well as horizontal, as by code, cladding is not expected to hold up its own weight—as well as being too slender to stand up on its own without ties to the wall structure. These cladding attachments being more critical in seismically active areas. The present inventor believes this vertical support requirement to be redundant for cladding of cementitious plaster or stucco in low rise structures—in that such a material can hold its own weight if continuously braced in a vertical plane, but this is a present building code requirement that generally must be satisfied. Recent code revisions allow for the wrapping of insulating foam over a built structure for improved thermal performance, where the cladding vertical and lateral support must still be provided, and these connections can be shown by structural calculation. The most efficient means to provide this required vertical support is to slope wall ties downward toward the cladding, so that the slope of the tie in pure tension can develop the vertical component of the cladding gravity support. This amount of slope can vary considerably and still do the job, from 0 to 45 degrees, though an ideal slope can be around 30 degrees from horizontal, where if a tie is actually carrying the entire weight of the tributary cladding, it would have a tension load of about twice that weight. Just as an example, if a ⅞″ (22 mm) thick stucco weighs 10 lb per sq ft, would potentially create about 20 lb per sq ft load on such a tie system from gravity load, due to the 30-degree-slope tension support. If only one tie per 2 square feet (very minimal), this is about 40 pounds (178N) sustained force per tie. Sixteen gage stainless wire is safely capable of around 60 pounds (267N) sustained tension force, so this approach is efficient use of tie material. Reserve short-term strength is required for seismic loads. If the ties are installed at a greater slope, such as 45 degrees, the cladding gravity loading is reduced to about 1.4 times the weight, and at a shallower slope the gravity-induced tie loading will increase. A goal for market viability of this system is to be able to demonstrate conventional building code compliance, which is not the case with contemporary 3D printing.

Another crucial advantage to sloping wall ties to the exterior is that any moisture that may get into the insulation and condense on the ties, will drain toward the exterior. Furthermore, any small channels that may be created by insertion of the ties into foam, will serve the same purpose of directing water toward the exterior or at least preventing it from migrating toward the interior. For this purpose, the slope can be very shallow, such as even a few degrees. For conditions where vertical support is not required and moisture intrusion may not be an issue-sufficient roof overhangs or interior walls-no slope is required; the ties can be horizontal-providing that any necessary vertical support of the cladding is somehow provided.

### FIG. 2

This shows an embodiment for each of the three significant steps to this wall fabrication process. All of these are primarily assumed to be digitally-controlled motion processes, driven by a large gantry system 12, such as those utilized for onsite 3D printing of buildings. Gantry 12 is shown with two of a gantry beam 16, which, supported by other gantry beams, move horizontally as a pair, and serve support for controlled horizontal and vertical motion of a vertical-motion member 14. The gantry geometry can vary considerably to achieve the same result. Also, any robotic or motion-controlled system can be employed to direct these devices, such as an articulating-arm robot with enough axes to allow linear/planar movement; and other digitally-controlled or non-digitally-controlled mechanical means, such as an excavator arm with an articulating attachment or the boom of a concrete-pumping truck, can be employed to direct these devices and systems. To assist in additively-manufactured elements in having smooth surfaces where a long boom is used, any boom oscillations can be compensated by a “POSITION AND ORIENTATION TRACKING SYSTEM,” by Mark Piver, PCT publication Number WO/2020/097685.

The elements in FIG. 2 can together serve as a system create the ideal wall assembly of FIG. 1, and/or each can independently act alone to develop that aspect of a wall assembly construction. These methods involve a controlled dispensing of building materials that is coordinated with control of the device motions, in order to effect a successful additive-manufacturing process. When this involves a cementitious material, the means of coordination has been well developed by many different groups, and this can include methods previously developed by the present inventor. For additive manufacturing with another material, such as an applied liquid agent that expands into insulating foam, details of foaming material and related application and travel rates have been worked out by other groups, such as the 3D-printing of a foam dome by researchers at MIT in 2017; and for what is claimed to be the first inhabited 3D printed home in France, built by the University of Nantes by first 3D-printing walls of foam. In both cases, the walls were first printed with a liquid expanding foam, in two wythes, leaving a void between for placement of concrete. However, in these and other cases, problems with their methods have been that the unconfined expanding foam results in a “billowy” or “pillowy” surface. It does not result in flat enough surfaces to be useful and cost effective for wall construction. A billowy foam surface either needs to be milled flat (which is what they did at the University of Nantes), creating excessive waste; or excessive cementitious materials are required to create the required minimum net thickness layer between the foam wythes, and particularly for cementitious cladding on both sides—where the variations in the foamed surface can and do exceed the preferred thickness for cladding. Both foam and concrete are wasted significantly (The MIT foam dome was never clad with a cementitious mix—it was just left as billowy foam). Furthermore, these methods have not been combined with zero-slump concrete methods, such as those developed by the present inventor, whereby their wasteful double-wythe foam placement can be avoided, creating more surfaces that subsequently need to be covered over; because with the present inventor's new methods, concrete does not need forms anymore.

Use of a foam-former 4 is now a possibility, even with extremely sticky urethane foaming materials (which adheres to any other material and itself in subsequent passes), because of a significant breakthrough in non-stick surfaces, which is a key part of the present invention. This new active non-stick surface, includes a continuously wetted hydrogel film, does not adhere to an active urethane adhesive, or any other non-water-based active adhesive tested (such as epoxy). This embodiment of foam-former 4 has two of a side plate 18, that can be of any rigid material, and one of a front plate 19. When combined with adjacent permanent surfaces, former 4 provides confinement so that when a liquid foaming material supply 22, along with air flow as needed for application, is applied via a nozzle 26, into the bottom of the space defined by former 4. Applied foam adheres to adjacent surfaces but not to exposed surfaces of the former, so that after the foam expands to the confines of former, the device is lifted upward the appropriate amount to repeat the process, creating a contiguous series of vertical pillars that create a wall of foam, this embodiment of the plane of insulation 1. The pillars can each have the same horizontal dimension (shift in the x-direction for the given pillar), or any can be of a different horizontal dimension as may be required to define a wall ending or opening.

The resulting foam material should be rigid enough to allow for a dimensionally-stable plane, so that subsequent surface layers can be applied. This would require something having a rigidity like a closed-cell urethane product of around 2 pcf density. As most urethane type of foam products cure by contact with moisture or water, the water-lubricated hydrogel acts to create a hard shell on the outer surfaces of the slip-formed foam, making the slip-formed “wall” plane beneficially more rigid. An example of a suitable two-part foaming material is the HEATLOK HFO HIGH LIFT, having a A-PMDI ISOCYANATE component that is combined with their HIGH LIFT resin, by Huntsman Building Solutions, 10003 Woodloch Forest Drive, Woodlands, TX. This closed cell foam can be placed in lifts of up to 6.5″ (165 mm) thick (high), that cure in 3 to 4 seconds, resulting in a rigid material having an effective R value of up to 7.5 per inch (1.31 Km\hat{ }2/W per inch), at thicknesses of 3.5″ (89 mm) or greater. This product has an ignition temperature of 408C, so when exposed to wildfire heat fares better than wood (behind an equal cementitious cladding), which has an ignition temperature generally accepted as 250C. Such a foam has application condition and equipment requirements that are familiar to contractors that provide this type of insulation. A “high lift” foam will generally be preferable for this application also in that these tend to generate less heat during their chemical reactions, and so can be placed continuously at a faster rate without scorching or shrinkage issues. Insulating foam material can include one that is a reaction product of polymeric isocyanate and resin, such as polyol resin, including those that are “water blown,” and/or based on soy or castor sources. If the resulting foam is of insufficient stiffness for subsequent construction loads, then manual bracing of this foam plane would generally be required for subsequent surfaces application onto a full-height wall, unless the digitally-controlled bracing means disclosed herein is utilized. Alternatively, the foam product can be one of a stiffness that can accept subsequent construction loads without the need for bracing, such as a higher density closed-cell foam meant for roofs (3 pcf) or even truck bed liners (10 pcf). Also, to avoid bracing, the slip-formed foam plane as disclosed, can be subsequently coated with a thin layer of very-rigid very-high-density foam, or similar rigid membrane-which can also serve as a water or vapor barrier, on both sides, before application of cementitious materials. With this process, a lower-density open-cell foam can be used for the core, such as 0.5 to 1 pcf, if preferred, and the foam material applied over can be a polyurea foam. Of course, foam manufacturers can develop foam products specifically formulated for the purposes of these methods. Another benefit of forming the foam, is that it promotes the development of a denser surface relative to the bulk mass (opposed to it being free to pillow out), because this effect is largely a result of the physical confinement. So the foam wall rigidity is also improved by the forming process.

Foam-former 4 has its multi-axis motion controlled by the z-axis member 14, which attaches with a yoke 20. The method can be also applied in a repeated horizontal manner such as most additive manufacturing, but the preferred vertical motion is possible because the extraordinary self-support ability of “printed” foam allows it. Upward vertical-motion additive-manufacturing is preferred, because then gravity helps prevent the sticky foam from adhering to the foam-former surfaces, because it allows precise, ordered vertical edges for window and door openings, and it allows staggered timing for window opening-frame (buck) installation (described furthered below). Horizontal advances can be of increments that terminate beneficially for architectural purposes, and to avoid elements of plumbing and similar elements that are pre-positioned, such as electrical or mechanical elements, and such as a pre-positioned pipe 34. Also, the sequence of placing foam first provides a scaffolding structure for positioning support of, and verifying proper locations for, plumbing, mechanical, or electrical elements-so they can be placed into position prior to placing concrete-which is the easy way. This, along with the novel methods of concrete placement, disclosed by the present inventor, allows wet concrete to be cast around the in-place elements, which is far preferable to creating these necessary voids before or after concrete placement. Preplacement of utilities allows for code-compliance inspection, and any corrections or modifications to be made, before concrete is cast. This is not the case with existing 3D-printing sequence.

The foam top surfaces are shown here to be smooth and flat, which can be achieved by trimming the foam, or other additive methods can be employed, such as utilizing a temporary, removable lid having the same active non-stick surface disclosed below, that the expanding foam can expand against.

Significant testing went into discovery of a surface that would not stick to a two-part urethane type of adhesive foaming material, even to a slight amount, and while the material is still tacky, as such a surface condition is necessary to allow a slip-forming process of the foamed material. This is a much more critical non-stick surface condition than is required for releasing the adhesion of cured foamed material. Many non-stick surfaces, such as those with a PTFE coating, can accomplish sufficient release of hardened foam, but none tested could slip the still-tacky urethanes, including a recently-developed “liquid PTFE surface” recent non-stick technology by Adaptive Surface Technologies Inc, U.S. Pat. No. 10,913,877: “Curable Mixtures for Forming a Lubricious Surface of Fluorinated Lubricants and Articles Made Therefrom.”

Non-stick surfaces also lubricated with water or other liquids did not work past the first lift, as tacky urethane “reached though” the liquid to make adhesive contact with the surface behind, even if of a non-stick material, in a manner similar to the behavior of adhesive graphics applied over a film of water (that is subsequently “squeezed” out). Such a scheme would almost immediately begin to accumulate some adhered foam, which then attracts more foam. It was determined that a viable slip-forming surface may need to be one that itself is of highly lubricious, and perhaps also a sacrificial, material, while working behind a lubricating liquid.

After extensive testing of many categories of non-stick surfaces that all failed, a surface material was found to work, which ironically is an adhesive product: A hydrogel bandage, a crosslinked hydrophilic polymer that does not dissolve in water, or dissolves slowly in water. It appears that the intricate hydrophilic network provides, when sufficiently hydrated, what become what is essentially a water surface—to the very minute tendrils that are also entirely saturated, leaving the extremely-sticky urethane with nothing to grab onto. A version that works for this non-stick application is those in laminate form that are normally used as bandage material, such for burn wounds and dermal electrode adhesion. This gel can be based on PVA, polyacrylamide, PAA, PAM and other similar water-absorbent polymers. When this hydrogel film is sufficiently hydrated, it was found to provide a phenomenally well-performing non-stick surface, for purposes of flip-forming (confining) a urethane foaming process. A water supply line 23 is indicated, as the hydrogel surface must be continuously hydrated, and so lubricated, for the non-stick properties to perform; and fortunately, many urethane types of foam formulations cure specifically due to a presence of moisture—and some require moisture in order to cure. The best-performing hydrogel discovered to date is a sheet material made for skin contact, product number KM50K, made by Katecho LLC, 4020 Gannett Avenue, Des Moines, IA 50321. This product is self-adhering, so it can be so attached to the inside surfaces of the foam-former. The hydrogel film material is also able to be adhered with solvent-based contact cement, for better adhesion. The film and adhesive need to be able to accept the heat generated by the foaming process. As these are surfaces that are slowly wearing during slip-forming, and they do need to be replaced at intervals, for that reason.

Another source for the hydrogel surface is Cardinal Health Hydrogels (Manufactured by Medtronic, 710 Medtronic Parkway, Minneapolis, MN 55432-5604, USA) which are made with an embedded mesh that can be installed high or low in the product. For this application, installing the mesh away from the surface will give a longer wear life. The products RG-72R and RG-73P are reusable membranes having a “high rewettability” property, which is what is beneficial for the present novel application of these adhesive products. These hydrogel laminates can have embedded structural mesh.

Longer-term practice of this method could lead to the need for a more durable hydrogel than the bandage wound type successfully used so far. One type of a more durable hydrogel material includes use of double network hydrogels, characterized by a special network structure that includes two types of polymer components with opposite physical natures: the minor component is abundantly cross-linked polyelectrolytes (rigid skeleton) and the major component comprises of poorly cross-linked neutral polymers (ductile substance). The former and the latter components are referred to as the first network and the second network, respectively, since the synthesis should be done in this order to realize high mechanical strength. This can include acrylamide polymer double-network hydrogels. These hydrogel networks can also be impregnated with a cross-linked cellulose nanofiber network, to form a triple-network hydrogel. These types of hydrogels have shown very high wear and fracture resistance, as they are developed for cartilage replacement. The surface abrasion durability can even be capable of resisting aggregates, so that these can be used for non-stick surfaces of concrete slip forms—for these hydrogel materials that can tolerate the high pH of Portland cement without excessive swelling.

From the University of Cambridge research on crosslinked hydrogels, Chemists Oren Scherman, Jade McCune, and Zehuan Huang write: “Supramolecular polymer networks are non-covalently crosslinked soft materials that exhibit unique mechanical features such as self-healing, high toughness and stretchability. Previous studies have focused on optimizing such properties using fast-dissociative crosslinks (that is, for an aqueous system, dissociation rate constant kd>10 s-1). Herein, we describe non-covalent crosslinkers with slow, tuneable dissociation kinetics (kd<1 s-1) that enable high compressibility to supramolecular polymer networks. The resultant glass-like supramolecular networks have compressive strengths up to 100 MPa with no fracture, even when compressed at 93% strain over 12 cycles of compression and relaxation. Notably, these networks show a fast, room-temperature self-recovery (<120 s), which may be useful for the design of high-performance soft materials. Retarding the dissociation kinetics of non-covalent crosslinks through structural control enables access of such glass-like supramolecular materials, holding substantial promise in applications including soft robotics, tissue engineering and wearable bioelectronics.”

Also included in its entirety by reference is U.S. Pat. No. 11,186,731 B2, by Aizenberg et al., Nov. 30, 2021, “SLIPPERY SELF-LUBRICATING POLYMER SURFACES”, and Grant U.S. Pat. No. 9,932,484-B2, by Aizenberg et al., “Slippery Liquid-Infused Porous Surfaces and Biological Applications Thereof.”

From the above references: Hydrogel Lubrication: “Most importantly, the coefficient of friction of gels, u, varies over a wide range and exhibits very low values (μ≈10⁻-10⁻⁴), which cannot be obtained from the friction between two solid materials. A repulsion-adsorption model has been proposed to explain the gel friction, which says that the friction is due to lubrication of a hydrated layer of polymer chains when the polymer chain of the gel is non-adhesive (repulsive) to the substrate, and the friction is due to elastic deformation of the adsorbed polymer chain when it is adhesive to the substrate.”

The new use of a hydrogel as a non-stick surface for foam forming or extrusion is not limited to vertical surfaces. The same hydrogel surface can be used to place foam in-situ with flat surfaces that are sloped, or horizontal, such as insulated roof planes. The hydrogel can be used as a movable or sliding supporting surface for placement of horizontal or sloped foam, spanning over an open space.

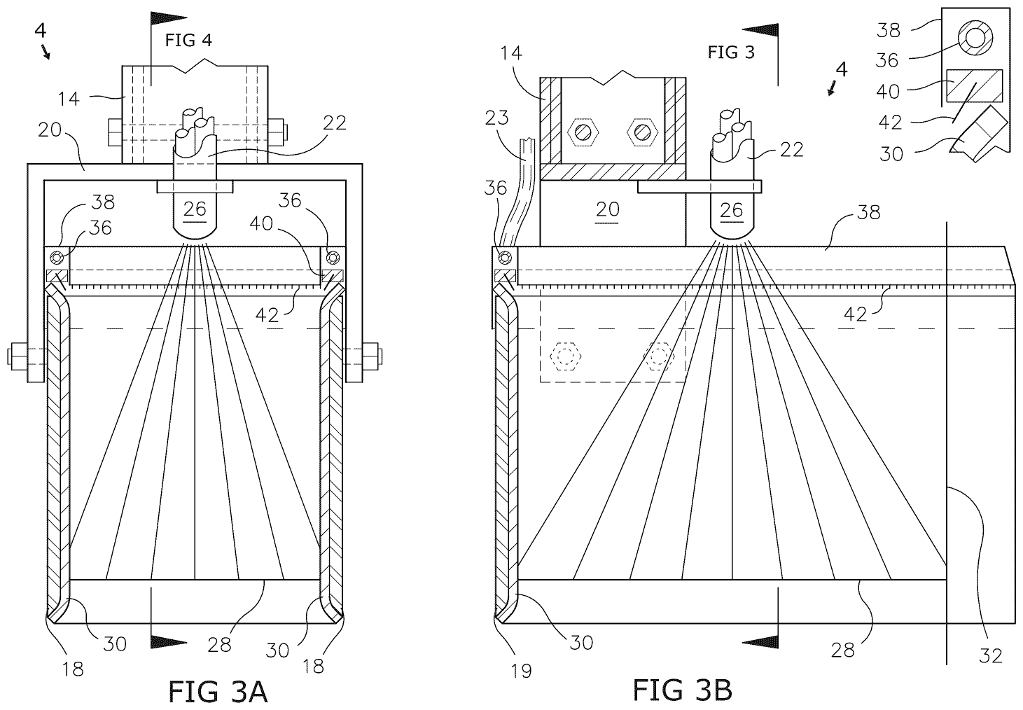

With this foam-first method, romex electrical wire 115 can be simply taped to the membrane 11, or to the foam 1. This is accepted by Building Officials, as this is the method of electrical wiring allowed with ICFs, except that in this case the wire does not require any recessing into the foam, as it is subsequently protected by the concrete wall. The “conventional” practice of printing concrete wythes first, requires the use of solid conduit for running electrical wire, which is much more expensive—both material and especially labor—than simply running romex wire without conduits. Alternatively, lengths of romex electrical wire can be loosely contained within the foam-former to make vertical runs in the foam wall. For this method, the foam must be acceptable for the presence of adjacent electrical wires. The foam-former is disclosed further below, as relating to FIGS. 3, 4, 5 and 6.

A vertical placement device 5 utilizes a proven concept for mechanical application of plaster, such as the “Plastering Machine,” a 1993 US Patent #578327, by Tan, Tah H, which has been improved on since. System 5 differs from all the prior art in that it electronically coordinates its motions with a controlled flow of plaster material 98, is controlled by a robotic means, the means of mechanical control can be from a separately-referenced platform (rather than the adjacent floor, ceiling, or wall), it can apply plaster significantly faster, and it is controlled and directed from above, not below. A plaster nozzle 100 modifies a cross-section flow of plaster from that of a circle (a typical supply hose), with the two of a nozzle shoulder 101, to form a high-aspect rectangular-shaped flow—so that a broad-width application of plaster can be applied at a given desired thickness. For example, a 20″ (half-meter) width can be applied at a 1″ (25 mm) thickness, in a particular vertical pass. A narrower width, less than a half-meter wide, is not a real detriment, in that this device motion can be much faster than other options—this system can apply material delivered at over a 100 liters per minute. Application thickness can vary from 0.25 to 1.5 inch (6 mm to 38 mm). Any cementitious or time-setting material can be applied, such as plaster, mortar, rendering, grout, concrete, and so on, here referred to as plaster.

The means to force the cross-section of plaster material flow to change aspect abruptly, yet still provide consistent-enough discharge throughout the nozzle (center to ends) for a relatively consistent thickness of plaster to apply, is to provide more resistance at the discharge than further back in the nozzle. In other words, if the flow path is easier, or just as easy, toward the shoulder 101 than straight out to discharge, then material will fill out the width of the nozzle more fully. The way to achieve this is to provide a taper created by a nozzle plate 103 to a nozzle terminus 102 sufficient to force plaster out toward shoulders 101 sufficiently. Further disclosures elaborate.

An optional feed surface 104 can be employed to provide a buffer between the flow rate of plaster and the vertical surface applied to, so that the flow rate of plaster does not have to be as precisely choreographed with the tool movement. A side shield 107, is shown only on one side, for clarity. This is to prevent plaster from spilling off the sides of surface 104, however controlling the flow of material is more critical to this goal.

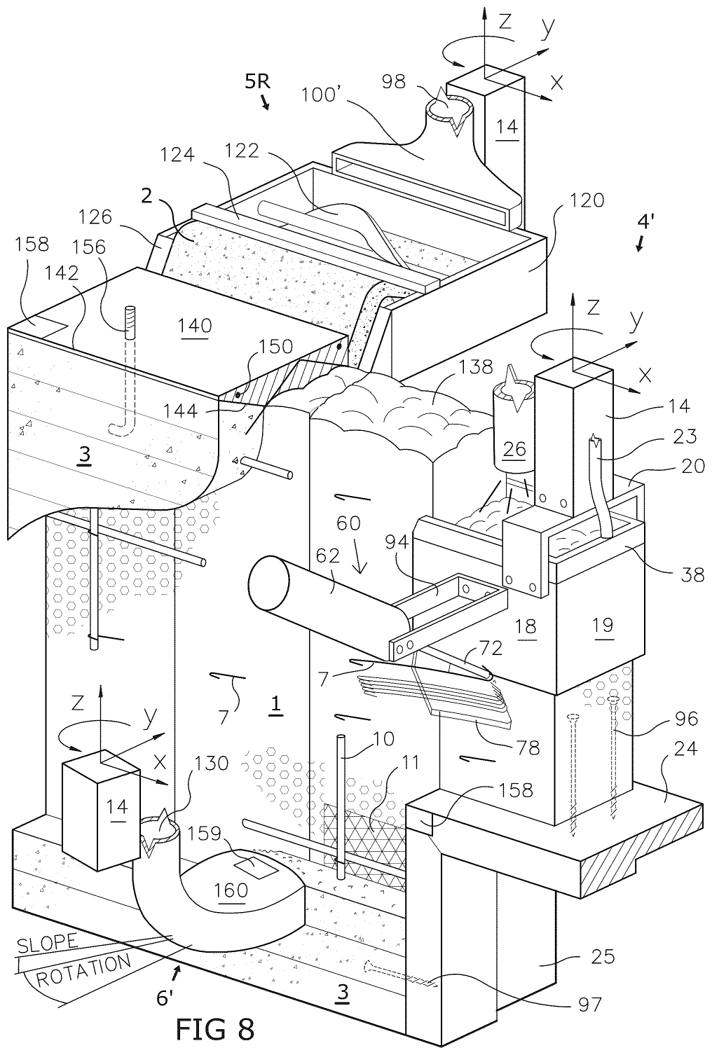

Vertical placement device 5 is shown to be directed by z-axis member 14. This motion control can be made by any of the other options discussed previously. System 5 embodiments are described further, per FIGS. 8, 9, 10, and 11, below.

A concrete placement system 6 can be per any of the previous embodiments disclosed previously by the present inventor, and/or ad modified herein and following. A controlled flow of concrete 130 is directed to a nozzle 132, for placement of concrete 3 against the surface of the plane of insulation 1. This can be considered to be 3D-printing adjacent to, or against, pre-positioned foam insulation. A screed plate 134 can be used to create a more-planar or smoother surface to the concrete wall, and one or more of a vibrator 136 can be employed to improve consolidation and interlayer boding of the additive layer process. The application here can be one of a smaller scale relative to previous disclosures, if this is more conducive to the process or equipment at hand. In other words, the gantry system proposed for slip-forming of foam and placement of plaster, may be lighter-duty than is ideal for only concrete, and in this case the concrete placement system can be scaled down in order to utilize the same gantry setup, avoiding other setup costs. System 6 is shown to be directed by z-axis member 14, this motion control can be made by any of the other options discussed previously.

The optional waterproofing layer 11 is shown between insulation 1 and concrete 3, as it may be needed for given conditions and materials. Membrane 11 can be a solid planar membrane adhered to the insulation, or it can be a liquid-applied membrane. The present construction sequence allows placement of such a layer, whereas state-of-the-art 3D printing with mortar or concrete does not.

The systems and modification of cementitious material properties, and the flow control of concrete pumping systems, as previously developed by the present inventor, are essential to the rapid placement of this material for these present applications. This is implied by the reference notations 98 and 130 for the input of materials, which must be tightly coordinated with the application tool-controlled motions, as developed by the present inventor and others.

### FIGS. 3A and 3B

A two-part urethane insulating foam product is commonly applied with pneumatic means, though this is not necessarily the case, such as for molded surfboard blanks. For the present application, either way will work (pneumatic or poured-liquid placement), but the pneumatic means is already commonly employed for insulation of buildings and the like, so that is shown here. This foaming process generally requires a surface for the just-mixed liquids to be applied to, for the foaming/expansion process to commence. The foaming material supply 22 shows 3 lines, part A and part B of the foaming solution, and an air supply for application. All of these materials can be set to flow according to settings for normal insulation operations according to the environmental conditions at application, as is practiced by foam insulation contractors; though in this case the downward projection is easier to control, and the air pressure setting can be lower than typically used for insulating walls and ceilings.

Foaming solution is applied against a bottom surface 28, which can be a starting surface or the top surface of previously-placed foam. Foaming solution will also then make contact, as it expands, with an adjacent surface 32, which is typically the edge of previously-placed foam. If no vertical surface is yet present here, the foam now-placed will just billow out like the previous art does, but this application should be minimal, to avoid mushrooming outside the intended planar surfaces for the foam. A subsequent pillar can be placed to expand against the first pillowed edge. For most foam products, the foaming solution completes expansion into foam within a few seconds, and then the foam former 4 can be lifted for another foam placement. The expansion amount can be a few inches to several inches, according to materials, environment and settings. As soon as just-placed foam is solid enough, the foam-former is lifted the appropriate amount, to repeat the process, to that top of a wall. It may sometimes be preferable (for some products) to spray foam solution in two applications for each single lift of the foam-former.

To prevent foam from sticking to the foam-former, all contact surfaces are of the non-stick surface 30, previously described. To keep these surfaces hydrated and lubricated, water is supplied with line 23 which connects to each of an irrigation line 36, present along the top edge of each plane of the device. Each of line 36 is an irrigation line that emits water at a controlled rate, such as the drip-lines with embedded emitters. Commonly these are ¼″ (6 mm) diameter and have emitters at 6″ (15 cm) on center. Each emitter dispenses about 0.5 gpm (1.89 Lpm) at normal line pressure, but flow rate can be reduced with a lower pressure. As the spacing for this application would preferably be as tight as 2″ on center, one of these lines can be cut and joined to provide this spacing. If the net lift for the foam-former is 6 inches (15 cm) tall and is fed water at ⅙ of 0.5 gph per 3 inches by 6 inches tall, which is about 0.00007 gallons per square inch per minute, or about 2 mL per square cm (of foam-former) per minute. If a foam lift of 15 cm takes 6 seconds, then about 0.0135 ml of water is consumed per square cm of foam surface installed, for lubrication purposes. Ignoring any water consumed by the urethane foaming chemical process, this is about 135 mL per square meter of foam, each side. For 400 square meters of wall (both sides) of a home, this is roughly 100 liters (25 gallons) of water required. This amount will vary considerably due to temperature and evaporation factors, etc., and can be adjusted to the rate needed at any point of the process.

Each irrigation line 36 is protected within a housing 38, which is fabricated from sheet metal of appropriate gage, such as 16 gage (1.6 mm). Below each line 36 is a permeable flow-control strip 40, which can be a length of open cell foam material, such as that of a dish washing sponge, cut to fit snugly between both sides of housing. The purpose of this strip is to distribute the flow of water continuously along the top edge of all planes of the foam-former. Along the lower edges of each strip 40 is a series of a drip control point 42, which can be a short segment of a plastic wire, such as 2 mm diameter by 12 mm-long, penetrated halfway into strip 40, at about 6 mm on center. The purpose of these is to create a water dispersal system by creating a dispensing (dripping) point at regular close intervals, so that all surfaces of each non-stick surface 30 are wetted continuously, where each surface 30 is of a hydrogel material described previously. Where this same purpose can be served in other ways, such as by a strip 40 having a serrated lower edge, this is fine, providing that the operation of the foam-former is level enough so that each of the drip points avoid water-contact with adjacent ones. Regardless of specific features, the purpose is to, as possible, replenished to the entirety of each surface 30 with water that is absorbed by the foam, and that leaves the surface by gravity and evaporation.

In some instances, such as when excessive heat has been generated or the flow of lubricating water has been insufficient, it may be necessary to move the foam former past (above) the previous foam placement, in order to enable rewetting the entirety of each non-stick surface. Then the former would be lowered back. To prevent this extra step, the hydrogel surfaces can be “primed” with an agent that provides some residual lubrication if they get too dry. For the hydrogel films tested, this can be something such as, glycerol, sodium alginate, polyethylene lubricants (such as DuPont Polyox WSR 308), sodium lactate, agar, or another suitable hydrophilic lubricating agent (that does not damage the hydrogel), and a compatible hygroscopic material helps prevent the hydrogel from drying out. The start of each new pillar provides an opportunity to wet all surfaces, and the machine tool path/process can easily be made to do this.

The panels 18 and 19 that make up the body of the foam-former can be of steel plate, such as from 3 mm to 6 mm thick. They can be welded to each other. Welded-on threaded studs can make the connections to the yoke 20, which can be of 9 mm steel plate, or the like. The top edges of panels 18 and 19 taper so that the wetting system described above supplies water to the forming surfaces, while housing 38 can maintain a flush planar surface with the inside planes. The bottom edges, and edges at the open end, are preferably also tapered, facilitating re-introduction of the foam-former over any already-foamed sections. Side panels 18 can have some draft, where the bottom edges are further apart than the top edges, to reduce “form” pressure and facilitate upward movement, as concrete vertical slip-forms often have.

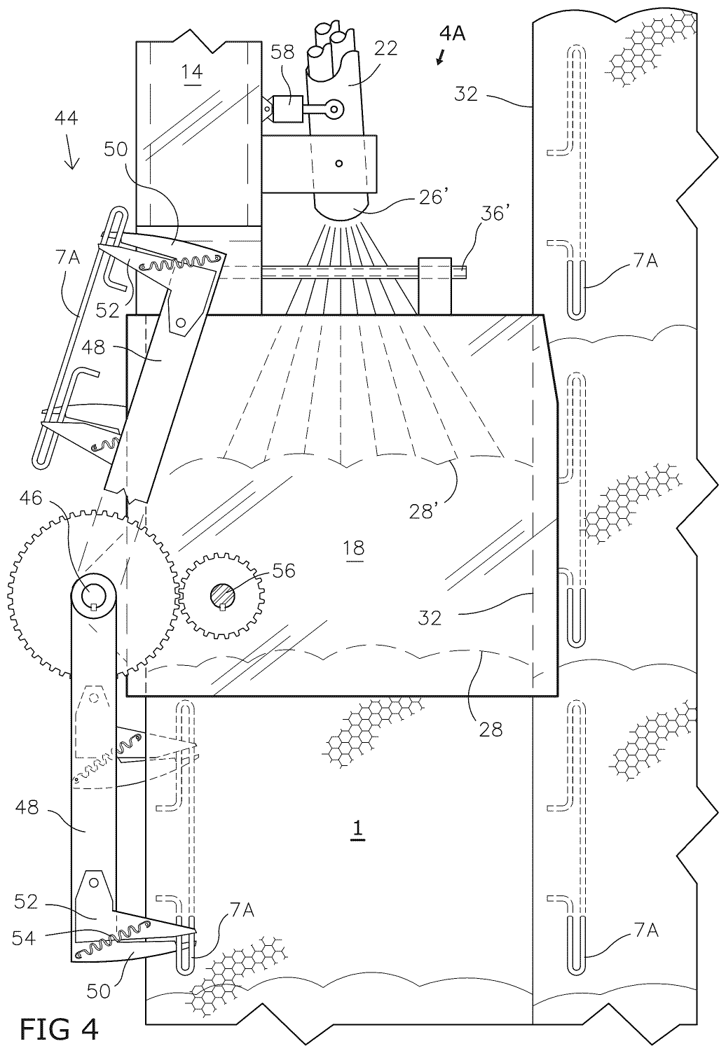

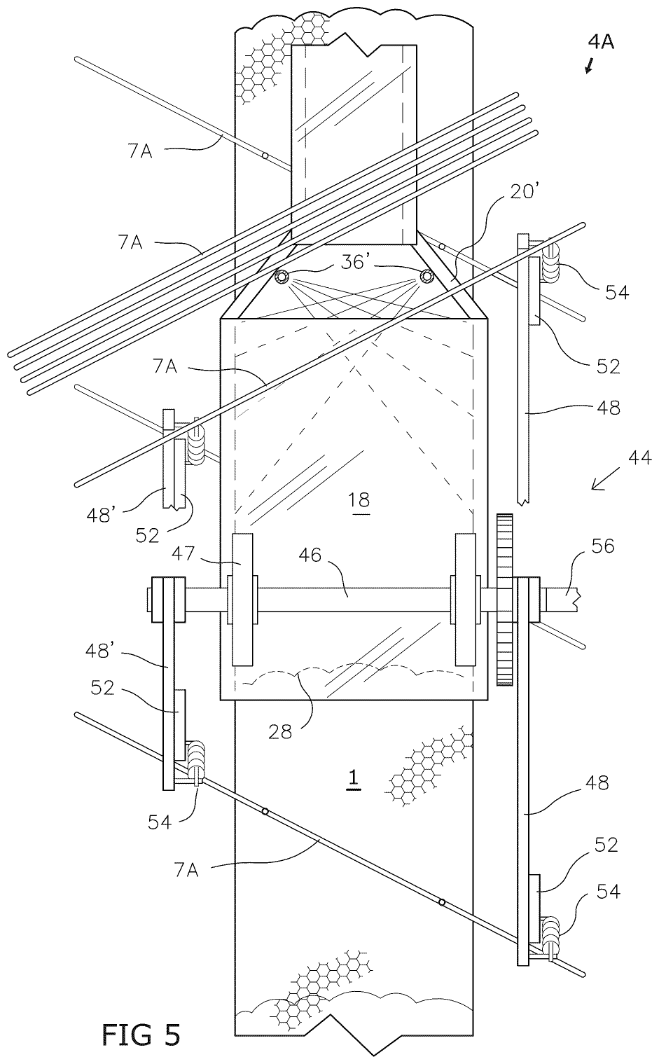

### FIGS. 4 and 5

These show a foam-former embodiment 4A that includes a rotational tie emplacer 44. Emplacer has two of an arm 48, where each can be of a different length to provide for emplacement of a sloped tie 7A. Each arm can have a fixed jaw 50 and a pivoting jaw 52 that is pulled by a spring 54, with a gap left so that as both arms rotate by link shaft 46, the gap can accept a tie 7A and hold it securely enough until emplaced into the foam 1. Shaft 46 is rotated by a powered shaft 56, with the stepper or servo motor, or the like, not shown. Then the reverse rotation of arms creates a motion releasing the pivoting jaws and so releasing the tie into the foam. At this stage of the foam-forming process, most often, the foam is still somewhat soft and sticky, facilitating the tie release. After arms swing back up and past vertical, so that jaws are behind a series of ties, which can be collated in a clip, held by a magazine (not shown), the subsequent tie is guided to a drop aligned with the jaws' opening for another placement. As the foam-former motion is intermittent (it pauses for each expansion of foaming agent) each pause in vertical progress allows for a tie emplacement. The idealized motion of foam-former is one where each lift of foam corresponds to a desired location for a tie, so that the vertical capacity of former will ideally correspond to a preferred or required spacing of ties. For example, where a code provision (that must be satisfied) requires a vertical spacing of stucco ties to be at 6″ (15 cm), then the foam-former should preferably be designed around the dimension as a minimum capacity or target for each lift. Likewise, a necessary horizontal spacing of ties should preferably correspond to a horizontal capacity of the foam-former.

The 7A ties shown here are of a design where each end has a length doubles back into the foam, with a hook, to provide more positional stability, and to have looped ends that can be wire-tied to more securely. The open end of former has the top edges chamfered to help in avoiding interference with previously-emplaced ties as it is lifted.

FIG. 4 shows a nozzle 26′ that pivots to oscillate, with that action created by a linear actuator 58. This allows a longer length of foam application coverage so that a longer foam-former can be used. Also shown is the nozzle spraying a second lift onto some foam that has already risen within the former. For such multiple lifts, the action of 58 can be greater, so that the closer surface is covered with a larger angle of spray, but with less time at any part of the closer surface, so that foaming agent coverage is more uniform.

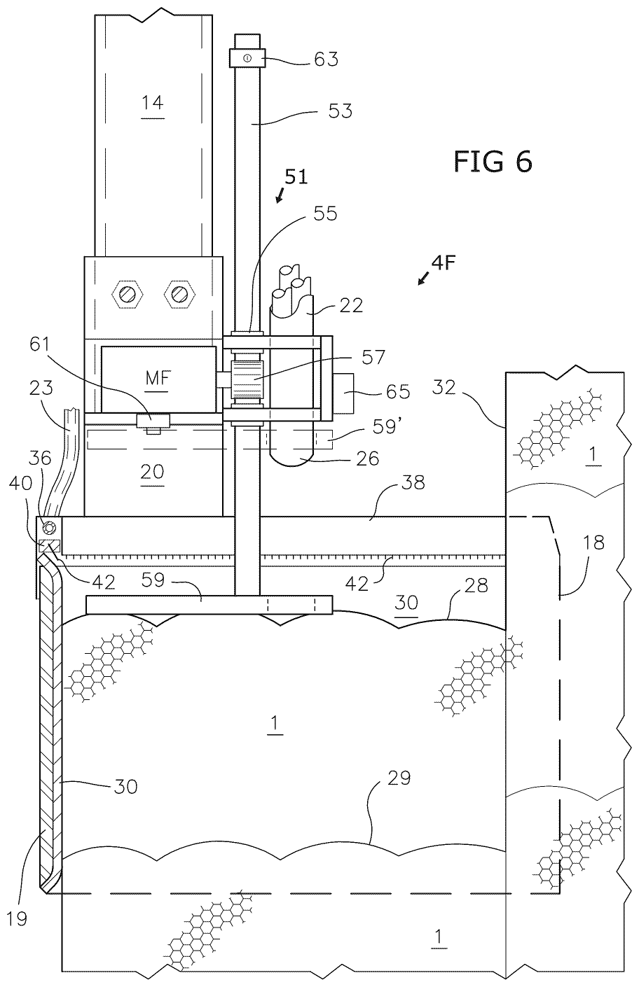

FIG. 5 shows spray lines of water from each of a misting line 36′, where irrigation misters are exposed to be able to spray directly interior surfaces (the spray lines shown in FIG. 6). This misting/spraying action can be in lieu of or in addition to the wetting system shown in FIGS. 3 and 4. A modified yoke 20′ and other appendages support these lines.

### FIG. 6

FIG. 6 has some reference numerals relating to discussions above, not repeated here. A foam former 4F is in the middle of building a foam wall 1, having a foam pushing system 51, and is shown as cut-away in the foam forming chamber. The purpose of this system is to accelerate the foam forming process, enabling subsequent lifts to be made while the foam is still setting up.

The foam for this lift has been placed and risen to the point where it stops rising, creating the surface 28. The risen foam cools and begins to harden on the top surface before the interior cools; the interior can still be gooey while the top is not sticky. The foam pushing system 51 holds the fresh foam down, pushing against the surface 28, as the foam former moves vertically for the next placement of foam. A square shaft 53, which can be a square steel tube section, is guided by two of a bearing, which can be Delrin, Teflon, or a set of roller bearings. A motor MF, which is tied into the gantry motion system, turns a friction wheel 57, so that a foot 59 can be raised and lowered. The foot 59 is shown against the just-placed foam. It is also shown dashed in the up-most position, where it can be seen that an orifice is required to avoid blocking the foam nozzle 26, and it must be in this position for foam solution to be sprayed. When in the up-most position, foot 59 pushes switch 61, so stopping upward-motion rotation of motor MF, and informing global system that foam solution spraying can commence. After a predetermined pause, such as a few seconds, after dispensing foam solution from the nozzle, motor MF is given the command to lower foot to the foam. A rangefinder 65, which can be capacitive, ultrasonic or IR, can inform motor the distance to the surface 28. Motor can move the foot very quickly to this distance, per controls. Alternatively, the pressure of motor and specifically wheel 57 can be released with a pneumatically-controlled or actuator or solenoid, so that the foot falls by gravity to the foam. In either case, the foot then is lowered by machine-control at the same rate that the foam former is lifted, so that the just-placed foam is held against the previous lift of foam while the foam former lifts. This way, any still-gooey material at the bottom of that lift will not begin to release from the lifting action, and the forming process can move faster.

Alternatively, the foot 59 and the shaft 53 can be of sufficient weight, such as around 20 to 35 lbs (9 to 16 Kilos), to hold the fresh foam down while the foam former lifts. So the foot is dropped and its weight substitutes for machine-control. A stop 63 prevents the foot from ever falling out if no foam is present. The friction wheel release stays off the shaft until the vertical motion is completed.

In either case, then the foot is retracted upward before the next application of foam is dispensed, then the process of holding foam in place repeats for the next vertical motion of foam former.

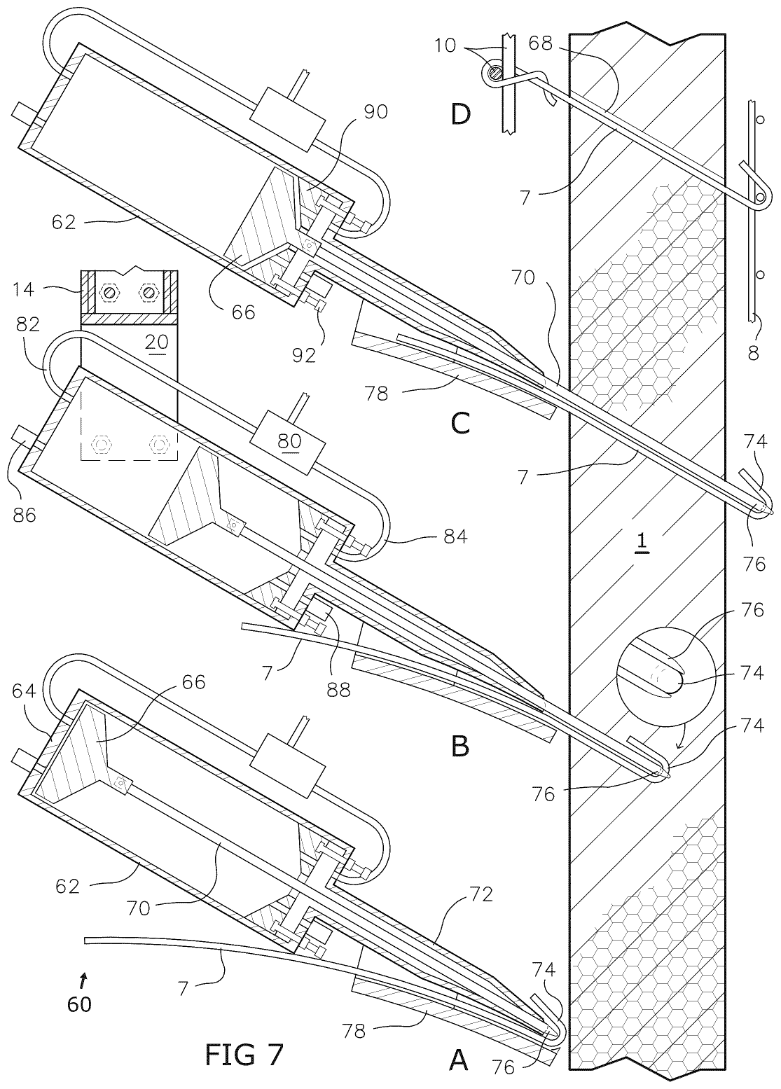

### FIG. 7

A tie inserter 60 is shown at various stages of inserting a tie 7. A casing 62 with an end plate 64 confines a piston 66 that drives a plunger 70 though a plunger guide 72. Plunger 70 has a tip 76 that engages a hook 74 of each tie 7. As the tip 76 drives the hook, it bends tighter about the tip, and is held tight to plunger by moving through the foam 1. As solenoid valves 80 direct air pressure though line 82 but not though line 84, valve 86 remains closed and valve 88 is open, so that pneumatic pressure drives piston 66. Tie end extends though the foam to the gauged location, as defined by an adjustable stop 90, which can be of a hard rubber material, that is adjusted by one or more of a threaded stop adjustment 92. Then solenoid valves 80 reverse, while valve 88 closes and valve 86 opens, so reversing the motion of plunger 70, to be able to engage the subsequent tie, which is collated in a clip, supported by magazine 78. This insertion mechanism can vary, and can be using the same mechanism as used for nail guns, though this insertion is of much lower load and velocity. Most any linear-actuator motion will also work. Tie inserter 60 can be guided by the gantry 12 (not shown) with z-axis member 14, attached by yoke 20. The reinforcing mesh 8 of a stucco cladding can subsequently drop onto tie, with its back end can tie onto rebar elements 10. Where a void 68 is created by the passage of the plunger 70 and hook 74, the slope toward the exterior directs any future accumulated water to the outer surface. This cavity is actuality is much smaller than these types of drawings indicate, and if the foam is still not totally cured, the void will heal shut. This effect helps to keep ties in position, for maintaining mesh location, etc.

### FIG. 8

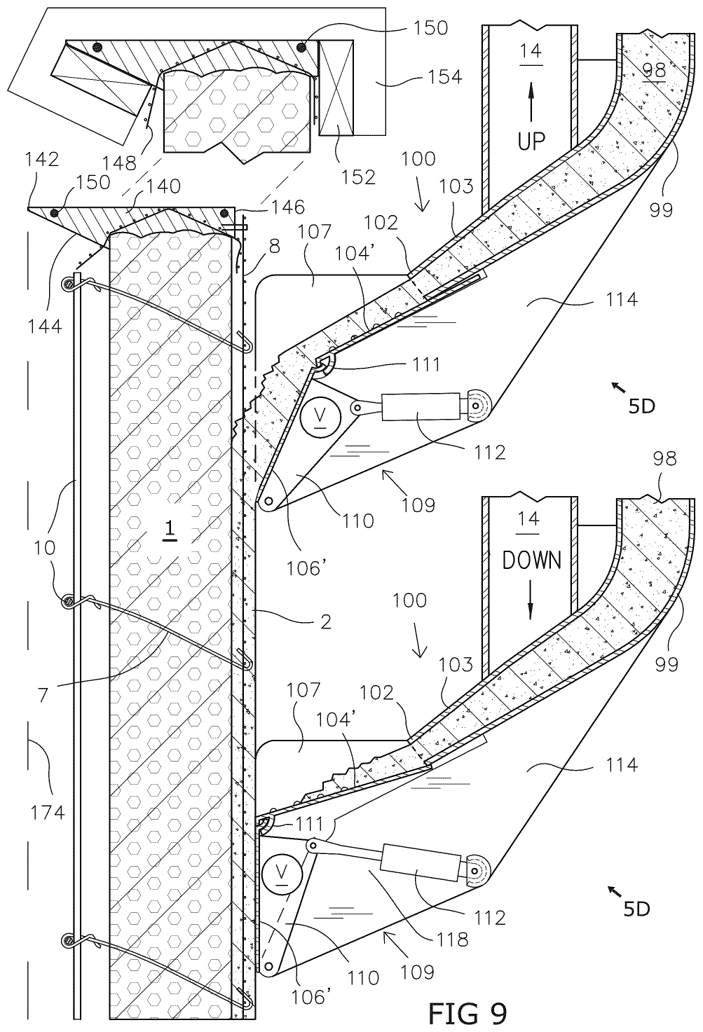

This shows some more detail and further embodiments of the novel wall-assembly construction processes. A top member 140 is created to provide more dimensional refinement and linear stability to the top of the foam 1. Ideally, member 140 can be extruded or cast over the irregular top surface 138 of expanded the foam. Member 140 can have an edge 142 that defines the finished surface of the concrete 3, but can be a narrow enough edge that a subsequent drywall ceiling hides it. Edge 142 connects with a lower surface 144 that has a slope, facilitating void-free placement of concrete beneath it. In other words, it can be difficult to place concrete from one side that fits snugly up to a level overhead surface, whereas with a sloped overhead surface is much easier to maintain contact with fluid concrete. Member 140 can be used for pre-positioning of roof attachment hardware, such as anchor 156. Member 140 is discussed further at FIG. 9.

A frame for a wall opening, with a horizontal member 24 and a vertical member 25, can define window and door openings precisely, similar to how window “bucks” are utilized with ICF construction. The frame installation should be coordinated with the foam-forming process, so that member 24 can support continued foam placement over openings. Member 25 would ideally have a vertical termination edge of the formed foam that locates it, and defines the vertical orientation if it. Member 24 can have a number of a shear transfer element 96 for improved temporary beam strength to support the weight of a subsequent placement of concrete 2. All such members can have a number of a screw fastener 97, or the like, for permanent anchorage into subsequently placed concrete for resistance to wind loads for windows, etc.

The foam-former 4′ is shown with the tie inserter 60 attached with a bracket 94, so that the insertion of ties can be made during the moments where the foam-former motion is paused. Bracket allow adjustment of the tie slope, in this case aiming downward toward the exterior. This view shows a collated clip of ties on the magazine 78.

A vertical placement system using elements of a rendering machine, 5R, can be used to apply plaster 2 to the side of the foam 1, as motion-controlled by z-axis member 14, and supplied plaster by nozzle 100′, fed by a controlled supply of plaster 98. Rendering machines are well developed tools that now have several manufacturers. These types of plastering mechanisms are disadvantaged in not having any material automatically supplied, and also in not having a continuous controlled flow of material suppled. To compensate for this, users will manually pile on enough plaster to make a trip up a wall without running out of material, so the material application function must be of a compromise that is able to accommodate both an initial heap of material pressed against the wall initially, and also for just enough material to finish to the top. In not having a globally-referenced motion-control system, the devices are too slow and take too long to set up, a task that must be repeated for each vertical pass. Also, their design prevents the application of plaster to the lower portion of walls, because of their underlying mechanism, and in that they need to be wheeled into place, and their guidance mechanism requires a rail to be set some distance from bottom of the wall.

Existing rendering machines are slow moving, but this is not critical, as most of the time consumed is in relocating the machine and setup for the next pass; and the plaster (render) is required to be manually placed. Informal measurement of promotional videos shows vertical placement rates to be at about 4 seconds per foot (30 cm), or 0.25 feet (7.5 cm) per second; a 10′ (3M) lift takes 40 seconds, and then another 33 seconds for the trip back down. For this same promotional video, of factory-trained personnel, with flawless practiced motions under perfect conditions, the relocation and reload of materials for the next lift required 95 seconds, the majority of the time consumed. This is a total of 168 seconds for each 10′ lift of wall, or effectively at about 0.06 (vertical) feet per second (0.018M/s), in the best case. And this is favorably for an 11′ tall wall (the machines do not apply to the bottom foot or so), which is more efficient than an 8′ tall wall having the same relocation time.

The present system, even if run at just the same vertical rate, would be of more than twice the effective net rate of application, in that relocation time is in the range of 5 to 7 seconds, about 4% of prior art, or about 28 times faster. Yet the present invention can place at faster vertical rates, and for rough coats, the smoothing (downward) pass can be avoided, so that rate of motion back down is limited only by the gantry equipment capacity. And in all cases, the present invention can plaster down to the bottom of the wall, so that the entire wall is plastered, which the prior art cannot do.

Importantly, as the present rendering machines require the manually-placed plaster to be “piled on” in a manner that creates a larger contact surface with the vertical substrate, and so the total force applied against the vertical surface must be greater to create enough applied pressure (per square unit of applied plaster area) in order to apply the plaster successfully. A controlled flow that supplies just the amount of plaster needed for application to the substrate, then allows a reduced total load against that substrate. This way the lateral load to member 14 can be reduced, so that, critically, the torsional load is reduced to the beam 16 pair (per FIGS. 2, 10 and 11). This load can be the controlling load for the design of a gantry system, for conditions when member 14 is extended and has maximum leverage. And this can be the controlling load for the design of an articulated robotic system. So, the design of the vertical placement system 5 should be that force which the robotic system can accept. The overall design of device 5 should be based on this criterion.

The version of vertical placement system 5R shown here has a spreading mixer 122, and moves plaster on a conveyor belt (obscured). As a controlled continuous material stream is preferable, a limiting bar 124 is intended to limit the cross section of plaster to that needed for application, helping to provide a consistent flow, but it does not perform well as a rate-controlling feature, in that stiff plaster does not want to squeeze under it, and extra material moves right over it. The plaster dispensing nozzle 100′ is shown with plaster material flow removed, for clarity.

While attaching such a rendering machine type of mechanism to a globally-referenced motion-control system and supplying a continuous supply of plaster, will function to apply plaster as shown here. However, the resulting system has unnecessary wear parts with clumsy geometry and function. Removing these unnecessary mechanisms can result in a more efficient and faster plaster application system with fewer moving parts, by taking advantage of a continuous plaster supply coming from above, and so essentially flowing from the nozzle to the wall surface, as shown in other embodiments of system 5. Though for this, several problems are needed to be solved-such as dealing with residual plaster that falls from nozzle even though the pumping system is shut off. These systems need a means to deal with the preferred amount of material flow. The existing machines are too slow for very efficient use, but increasing the rate of travel and acceleration between upward and downward motion exacerbates the tendency to lose plaster, and faster material consumption causes other motion problems. Improved systems are shown on drawings 9, 10 and 11. These that provide only the plaster flow that is needed, will reduce a common tendency for plaster to drop off the device, particularly one with faster motions.

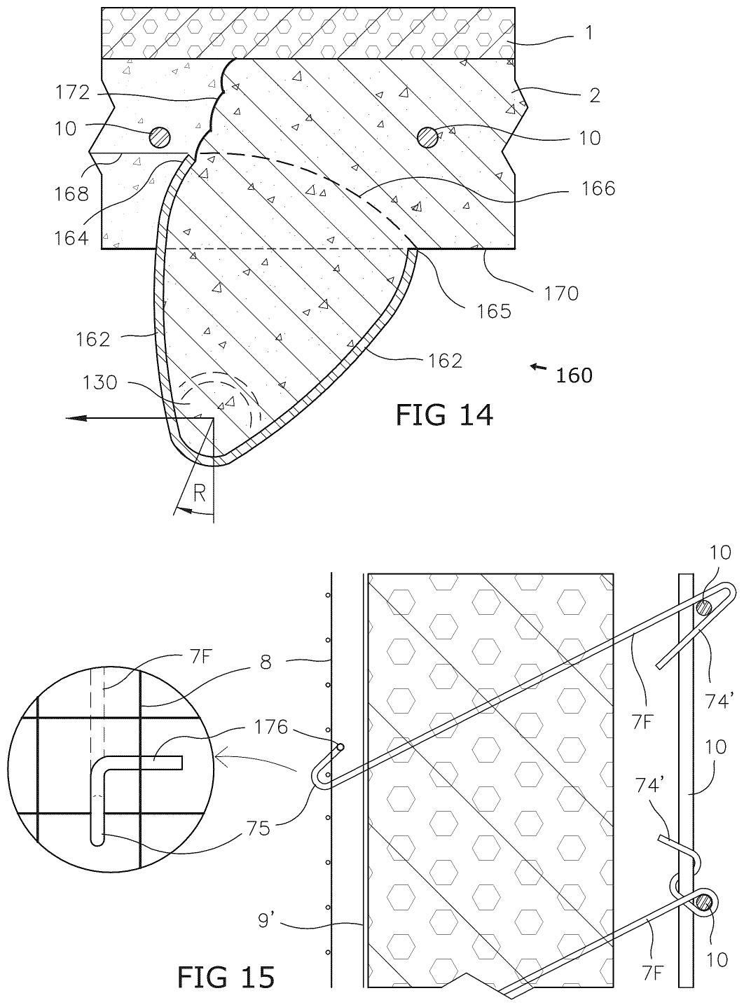

A crab nozzle 160 allows concrete placement to be made from the side of an additively-manufactured wall plane, where a maximum physical projection of concrete placement can be made into the wall plane, while also screeding off the outer finished vertical surface of concrete as it moves laterally. This can be considered to be as 3D-printing adjacent to, or against, pre-positioned foam insulation, or another horizontal surface. The crab nozzle uses a rotation about the z-axis to allow a leading edge to penetrate the finished plane, while a following edge defines the outer plane of concrete (This is shown more clearly on FIG. 14). Also, an advantageous slight amount of slope toward the outlet helps to avoid interference problems with the previously-placed “filament’ of concrete. When the crab nozzle reaches the end of its path, it can lift up a filament height, rotate to a mirrored angle, and proceed in the opposite direction. With the disclosed modifying admixture, this doubling up of filaments is not difficult. Alternatively, the carb nozzle can be moved back to the starting edge for another pass. This motion can be repeated between control joints (not shown), as is a common preferred practice.

This embodiment of the crab nozzle 160 preferably has sides with curvature along the direction of flow, which allows for a widening of the flow section, then a narrowing, with increasing such curvature, of the flow cross-section, at the outlet. Such a geometry provides for a means to create a more-even discharge throughout the width of the discharge section, by providing more resistance for concrete at the discharge (because of the smaller section), and so providing paths of less resistance for material to fill out the volume of the nozzle. This is similar to nozzle 100, which applies the same type of principle in the geometry of a vertical plane.

An RFID tag 158 can be placed at each corner of a frame (door or window frame), so that an RFID reader 159 can determine the location of each frame, for purposes of subsequent concrete or plaster placement. Similarly, an RFID tag can be placed at the top edge or end of a wall. An RFID reader can be attached to a material placement tool, such as the nozzle 160, or the z-axis member 14, so that the relative location to a wall opening, and the related frame, can be accounted for in subsequent tool paths and material dispensing. Any variations between initial digital model and actual physical object, intentional or not, can be established for a corrected/modified digital model. The tag 158 can be passive or active, and the RF communication system can be HF, UHF, or Bluetooth. The antenna of the tag would preferably align with the frame edge that defines the edge of concrete. As many of the tags as are helpful can be attached, also for such locations as obstructions or pipes that may interfere with tool paths. Other electronic or radio-frequency transmitters can be utilized in lieu of RFID tags.

Alternatively, the frame material can be manufactured with a series of RFID tags embedded into it, along the edge closest to the machine-controlled applied materials. Providing that each member of a frame has at least two tags, the RFID reader can extrapolate the locations of frame corners. For example, the reader can inform the material application system where to stop, and the system can make optimal adjustments to placement widths of a series of material placements, in order to complete a wall material placement right at the edge of an opening, without needing one last unusually-narrow inefficient placement.

The TurboTrack system developed at MIT makes two key technical contributions to increase the accuracy of RFID reader location sensing of RFID tags, so that robotic systems can rapidly sense tag locations to sub-centimeter accuracy. According to the MIT Researchers: “First, it presents a pipelined architecture that can extract a sensing bandwidth from every single backscatter packet that is three orders of magnitude larger than the backscatter communication bandwidth. Second, it introduces a Bayesian space-time super-resolution algorithm that combines time series of the sensed bandwidth across multiple antennas to enable accurate positioning.” A reader sends a wireless signal that reflects off the RFID tag and other nearby objects, and rebounds to the reader. An algorithm sifts through all the reflected signals to find the RFID tag's response. In their case, the final computations then leverage the RFID tag's movement—even though this previously decreased precision—to improve its localization accuracy; in the present case the RFID readers are moving. The Turbo Track system can replace computer vision for some robotic tasks. As with its human counterpart, computer vision is limited by what it can see, and it can fail to notice objects in cluttered environments. Radio frequency signals have no such restrictions: They can identify targets without visualization, within clutter and through walls.

Alternatively, or in conjunction, the frame placement system and concrete placement system can include radar or lidar sending-receiving systems that can locate and identify geometry for placing frames to match the wall plane surfaces, and subsequently locate and define the placed frames, to tailor the concrete placement to match the frames. In any case, the frame, with or without embedded electronic devices, can be used for guidance of the machine-controlled concrete and plaster placement processes.

### FIG. 9

This shows two section views of a vertical placement device 5D with a linked plate shutoff system 109. From above, a controlled flow of plaster 98, reaches an elbow 99, which inclines the plaster flow to align with the slope of a plaster nozzle 100.

The upper view is of the system moving upwards while applying plaster, and the lower view is the system smoothing off the plaster surface as it moves down. In the upper view, the feed surface 104′, supported loosely by at least two of the gusset plate 114, is slid partially under the nozzle 100, so that it is roughly parallel with the bottom plane of the nozzle. It is interlocked with a plate link 111 to the trowel plate 106′, which is supported by two of the web member 110, each connected to the linear actuator 112, controlling its angle of inclination against the plaster. Where this system of physically-hinged plates makes up a linked plate 109. In the upper view, the linked plate is accepting a flow of plaster from nozzle, and the angle of trowel plate 106 is adjusted for preferable application of plaster while the system is moving upward. A vibrator V can be activated to assist a stiff plaster flow fast enough down the feed surface and trowel plate.

At the top of the upward motion, and for smoothing of plaster on the corresponding downward motion, the actuator 112 pushes plate 106 to vertical, or slightly beyond, for smoothing purposes. The linked plates system 109 geometry simultaneously reduces the amount of slope to feed surface 104, effectively stopping any residual falling plaster from ruining the fresh plaster surface being smoothed. Surface 104 can have a series of bumps so that a fairly wet plaster does not continue to slip toward trowel plate 106 even when the feed surface is in the more-horizontal position. The trowel plate 106 can have any of the water-lubricated systems presently or previously disclosed by the present inventor, such as the “water screed.”

The plane of foam 1 is shown with a number of the tie 7, permanently attaching mesh 8 to the future wall structure, by tying them to the rebars 10. The top member 140 can be cast-in-place or extruded-in-place onto the top surface of foam 1. The top member is beneficial to maintaining a stable geometry of foam 1, and so is a structural member in this sense, as well as very possibly serving as the chord member of a roof diaphragm system. However, it should not be a detrimental thermal bridge-so the material choice is very important. Strength, stability, and holding of fasteners (such as the staple shown holding the mesh) are required, but without substantial thermal conductivity and material cost. This can be a partially-foaming thermoplastic curing resin with cenosphere and cellulose particle fillers, or cementitious with eps bead and fibered fillers, providing a strengthening resin is included. The form board 152 and frame 154 are shown for a cast-in-place option. The edge 142 is shown to align with or define a surface of concrete 174.

The inset view of the top member (above) shows further detail. To assist in composite action of the wall surfaces, and increase its own strength, top member shows a mesh strip 148, which is preferably of high-temperature-resistant, synthetic, fibers such as glass or basalt, treated alkali contact. Light stainless-steel mesh can also be acceptable thermally. For wall-construction stiffness and chord-member requirements, two of a linear reinforcement 150 are placed, each aligned as far from the other as can be, while maintaining material corrosion protection as needed. Reinforcement 150 can be a galvanized steel cable, such as ¼″ (6 mm) diameter, of 7×7 strand manufacture. Such a wire can be formed to a definite bend at wall corners, and can be spliced at nearly full strength with nicropress fittings and the like, so lapped-splice strengths within such a narrow member do not have to be relied upon.

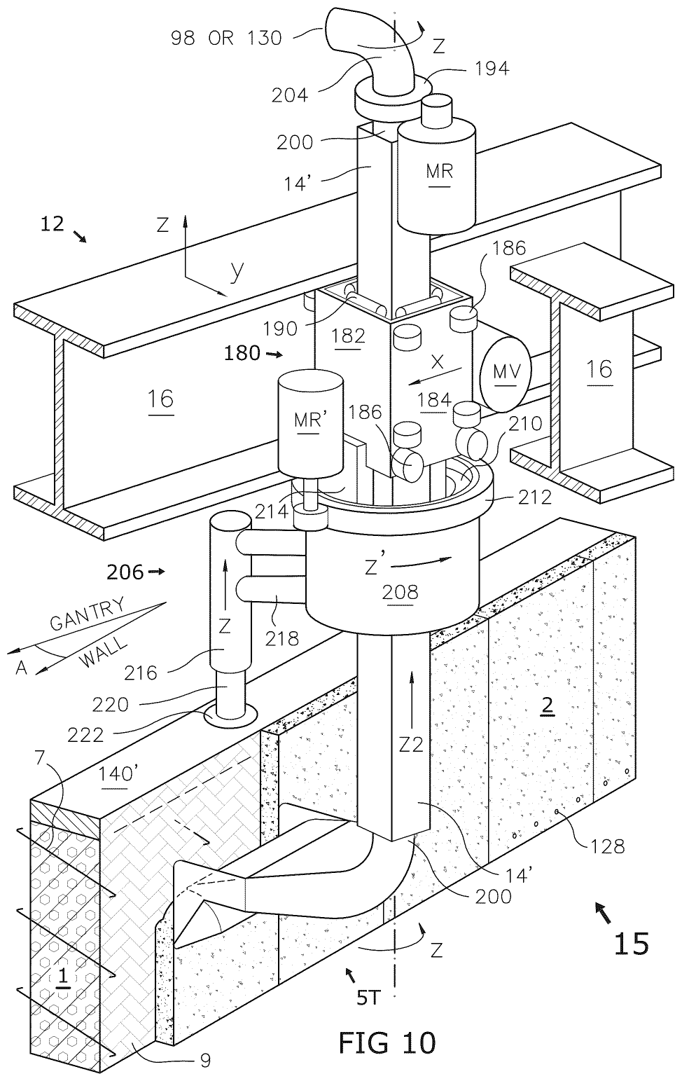

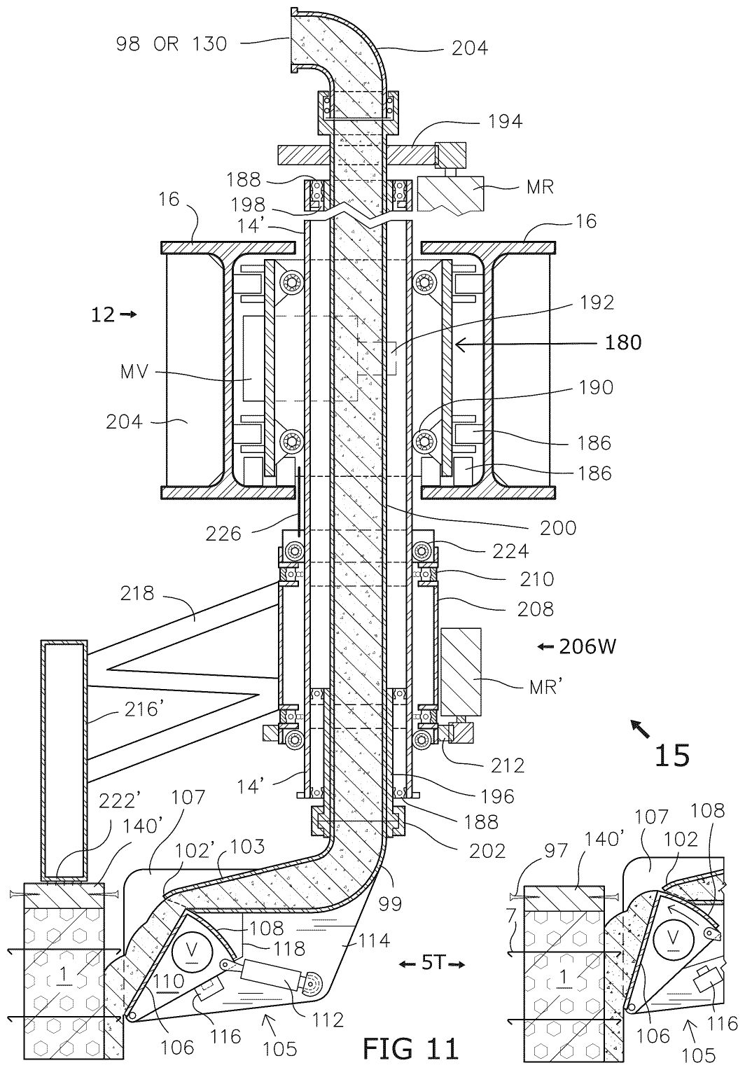

### FIGS. 10 and 11

There are some variations in embodiment. The common elements and FIG. 10 version are described first. The z-axis member 14, or the like, is required to allow tools controlled by a gantry system 12 to gain access to surfaces of the foam plane 1, where the foam plane itself would otherwise interfere with normal gantry motions (lacking a z-axis member). A vertical axis system 15 provides control of a tool, such as a vertical placement device 5T, to be applied to surfaces of the foam plane 1, that may not align with the gantry axes, and while also bracing the foam plane for the out-of-plane loads imposed from applying materials.

For the gantry motions, an x-axis carriage 180 provides tool x-axis motion along the lengths of both beams 16. This is shown as conceptual, as the carriage itself and the gantry system is not new. A pair of beams is designed to best address lateral forces (taken as torsion) imposed by the tool on an extended z-axis member. Beams are shown as wide-flange sections (rather than space-trusses), and rolling tracks are not shown, to simplify the drawing. Two of a side plate 184 accept x-axis rollers 186 as necessary for both horizontal and vertical loads, and as described above; in this case simply shown as rolling on the beams, which is conceptual. The distance between rollers would need to be greater than shown here. Two of an end plate 182 complete the carriage box, and also support the z2-axis rollers 190 along with the side plates, and also at the bottom of all, so member 14′ can move vertically within carriage, at any of its locations in the x-y plane. It is powered to do so with motor MV having a pinion that runs a rack, both on the far side of 14′. This motion of 14′ is termed the z2 axis in that the gantry itself 12 can have its own z-axis action by the lifting of the beams 16.

Per FIG. 10, this z-axis action lifts the carriage 180 that also lifts a wall brace system 206, by use of two of an attachment gusset 214. These gussets support a pair of a ring bearing 210, for attachment of a rotation drum 208, driven by motor MR′ to ring gear 212. This mechanism allows for rotational alignment of a rigid arm 218, so that the gantry z-axis action can lower a spring-loaded foot 220 onto the top member 140. A spring is inside a hold down tube 216, which can also house a dynamometer to tell the gantry z-axis action to stop. A friction pad 222 has small spikes or the like, to secure the top member and the foam plane for application of out-of-plane loads from plaster application, in this case.

Where a wall axis does not align with a gantry axis, the plaster tool 5T must be able to rotate to any angle. To accomplish this, a z2-axis pipe 200, which is also a conduit for plaster or concrete, is supported only by sets of bearings, to rotate 360 degrees within member 14′, with its orientation controlled by motor MR onto gear 194. Material 98 or 130 is supplied via a swivel elbow 204. Normally the tool orientation is going to be the same as the wall brace system 206, but they need separate controls because their z-axis motions are distinct. If the plaster tool location shift was at the top of each pass, that motion could be efficiently used to simply lift and shift the brace to the new location, but unfortunately the plaster tool shift (for a new lift location) is at the bottom of each pass.

Cladding 2 can have a series of a weep hole 128, above grade, to assist any required drainage from the wall assembly. The need and usefulness for these depends upon the materials used for construction, and the in-situ environment. If an open cell foam is used in a wet climate, a means of moisture drainage is beneficial to the interior environment. Alternatively, this can be continuous flashing at floor level that extends through the foam and projects out to the face of the plaster cladding.

FIG. 11

This shows a variation where system 206′ references it orientation from the (square tube) z-axis member via sets of rollers 224, rather than referencing from the carriage 180. And 206′ uses at least one vertical tie 226 for vertical reference (only) to the carriage, and simply utilizes the weight of the brace structure to pin the top of the wall. In either version, the brace can have two points of contact with the top member 140, for increased stability.

More detail is shown for support of pipe 200, where at each end it has a doubler tube 196 that is machined for fit of sets of bearings 188 and a thrust bearing 198 (at the top). Bottom doubler is of a length to help with bending strength from plaster tool loads. A nozzle coupling, allowing clean out of the system, is similar in mechanism to an HD concrete line coupling, but needs to be stronger, and to have an directional alignment key.

Two section views are shown of a vertical placement device 5T, which has a Tainter valve 105 that stops material from dripping out of nozzle when the tool switches to smoothing mode. In the application (open) mode, the lineal actuator 112 is holding an arc surface 108 (with its arc center coincident with the valve pivot) is clear of the nozzle opening; it is accommodated by a cutout 118 in each of the gusset plates 114. One web member 110 is pressed against a flow switch, holding it in the open position. A vibrator V can be used to assist material flow. In the inset view to the right, the actuator has made motion to close the valve, where the arc surface 108 blocks flow from nozzle. The motion will continue to where the towel surface 106 acts to smooth the plaster surface on the way down. This is not a pressure-tight blockage; it serves to stop loose material from falling from nozzle, not only to prevent marring of the fresh plaster surface, but also to maintain material volume that is calculated for use on the following pass. The switch 116 is released to confirm the shut off of flow of plaster, so that pressure does not build up onto this valve system.

This nozzle has a curled-in top plane of terminus 102′, to accentuate a pressure rise, helping to fill out the flow across the width of the discharge. A top member 104′ can be a length of 2× lumber material, pressure treated for contact with concrete, and is adhered to the top of the foam. Screw fasteners 97 are used for bonding plaster and concrete to the top member.

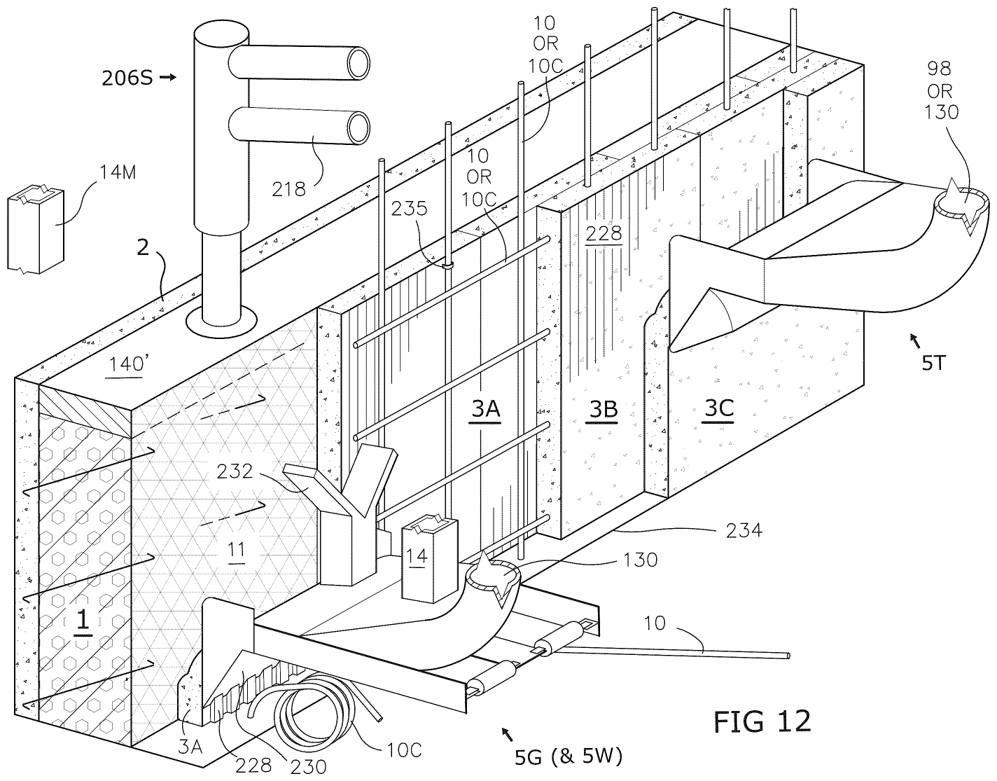

### FIG. 12

This shows a method to create a concrete wall with vertical application of concrete, where the effect of adhesion to a vertical substrate is exploited to provide a very rapid vertical placement of the concrete. To achieve a full thickness required for a structural concrete wall, the vertical placement can be made by subsequent placement of vertical layers, shown here as 3A, 3B and 3C, with time provided between the layers to prevent sagging. Modification of the concrete to hold a vertical surface is preferable, according to the methods and compositions by the present inventor, referenced above. Reinforcing can be situated as required, within a specific layer, and it can be held in place against a previous layer of concrete. Interlayer surfaces can be made to have a rough, grooved surface, so that interlayer bonding is not any issue.

Plaster cladding 2 is shown already applied to the far side of the wall. Now the process of concrete placement has begun, but with use of the vertical placement method. A vertical application system that makes grooves, 5G has a toothed edge 230 on its trowel plate, so that a grooved surface 228 can be created on concrete layer 3A. The toothed edge can be a comb, such as us used to scarify stucco “scratch” coats. System 5G can be supplied with a controlled flow of concrete 130, and has pressure conduit sizes and nozzle clearances for the size of aggregate to be used. As the thickness of each placement (3A, 3B and 3C) will generally be in the 1 inch to 1.5 inch (25 mm to 38 mm) range, which gets to the outer bound or where surface adhesion provides benefit, however having coarse aggregate helps in this effect. For these thicknesses, ⅜ inch (9 mm) aggregate is appropriate. Making interior layers relatively thicker and a finish layer thinner can be an optimal process. As the interior layer placements are not visible, it is less important to control any loose concrete that may drop out after a given placement (causing surface cosmetic damage), so a nozzle shutoff mechanism is not shown here, as it is not necessary in this application. In any case It is beneficial in terms of avoiding material loss.

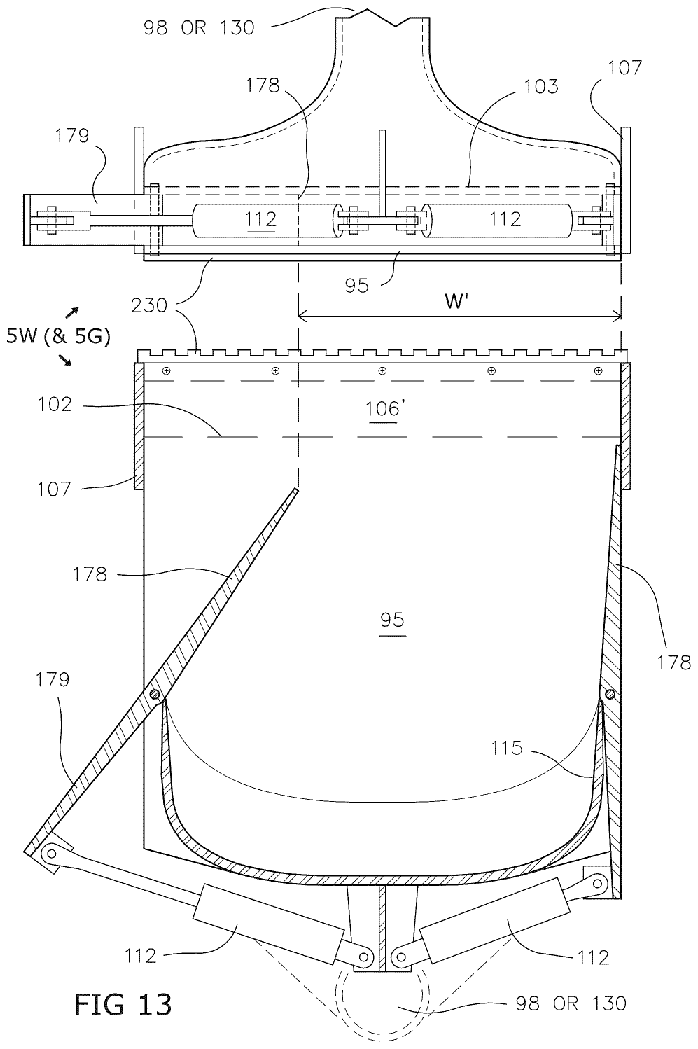

A vertical placement tool having width restriction adjustment 5W is also shown here, in combination with tool 5G. This vertical placement tool has both features, with the 5W width restriction mechanism shown more clearly in FIG. 13. More precisely, this tool designation would be 5WG, in having both features, and if it also had the Tainter valve, it would be device 5TWG. The W and G features can be combined with T, D, and R.

As the interlayer surfaces (3A and 3B) do not need to be smoothed, system 5G does not need to make a downward smoothing pass. Therefore, all these placement passes are upward-moving, and so each pass ends at the top of a placement. This tool path pattern facilitates the 5G motion-controlling system, such as the z2-axis member, (14′ controlled by the gantry 12 of previous figures) to also lift and reposition the brace system 206S for each new pass. Because of this tool path advantage, it is practical to use the vertical placement system motion-control as control of the wall bracing. So, the brace system 206S does not require its own motion control system; it can simply slide and pivot along the z2 axis, with the vertical placement system letting it down to the wall top member 140′, by its own weight, which for most projects, should be in the range of at least 50 lbs (23 Kilos). To lift brace 206S back up, the vertical placement system has a saddle 232 that cradles rigid arm 218, to lift the brace system 206S, and then lower it at the next placement location. Then the vertical placement system runs to the bottom of the wall before beginning to dispensing concrete and apply it to the wall, as 5G is shown doing in FIG. 12, starting another vertical-lift of layer 3A.

If any pre-placed reinforcing bar 10 (already embedded in a foundation shown with line 234) will interfere with system 5G, the bars can be turned away in order to be clear of tool paths. After the layer 3A is placed and set enough, any necessary reinforcing can then be positioned essentially against that layer, and can be affixed in place, though layer 3A, such as with a fastener 235 attached to the tom member 140′. The reinforcing can then be embedded within the next layer, 3B, which should also have a grooved surface 228. This process assures that required rebar cover is provided. Layer placements are shown with the edges of vertical-lifts staggered between adjacent layers, but this is not critical, particularly with the admixture compositions developed by the present inventor that minimize concrete plastic shrinkage.

Alternatively, rebar tails only, can project from the foundation, and device 5G can have a vertical dimension to its trowel plate 106 such that it clears those rebar tails when they are vertical. Then after layer 3A is placed, full height lapped rebars can be installed. Alternatively, full height rebars can be epoxy glued into the foundation after layer 3A is placed. Though for this practice, present building codes require a 21-day minimum delay after the adhered-to concrete (the foundation) has been cast. Threaded elements that attach rebar reinforcing can be used, but these are too expensive for residential construction; however continuous threaded rods (using couplers at the foundation) can be very effective in threading directly to hardware attached to the roof structure for high wind exposures.

An effective approach is to use embedded wire cables or sheathed pre-stress tendons 10C for vertical reinforcement, in that these can easily be coiled up out of the way of layer 3A concrete placement. Wire cables can be 7×7 galvanized wire construction. Post-tension cam-attachment fittings, or cable connections, can be employed at the top of walls or within a cast-concrete roof structure.

Placement of wire reinforcing during 3D printing is developed at the Eindhoven University of Technology. The 3D concrete printing system adopted by the TU/e has been described extensively by Bos et al, in a publication by “Materials,” 2017 November; 10(11): No. 1314. Published online 2017 Nov. 16. doi: 10.3390/ma10111314, PMCID: PMC5706261, PMID: 29144426, “Experimental Exploration of Metal Cable as Reinforcement in 3D Printed Concrete,” by Freek P. Bos, Zeeshan Y. Ahmed, Evgeniy R. Jutinov, and Theo A. M. Salet.

For this project, the printer head, which previously included of a simple stainless steel print nozzle, was expanded with a ‘reinforcement entraining device’ (RED) that allows the introduction of a reinforcement medium to the concrete filament. The concept of the RED includes of a rotating spool feeding the reinforcement into the printing head where it is introduced in the concrete filament so that an integrated concrete-with-reinforcement filament leaves the print nozzle. This concept was developed into a working prototype following a trial-and-error type process. Recently, an updated version has been developed that can hold more than 2000 m of cable wire, divided over two spools.

This development is significant is allowing the insertion of wire reinforcement during the additive manufacturing process. However, this development can only be used to create horizontal wire reinforcement, as that is the only means of layered 3D additive manufacturing concrete developed to date. The present invention allows this wire reinforcing method to also be used for vertical, as well as the horizontal, reinforcement during the additive manufacturing process. Any embodiment of device 5 can be outfitted to lay vertical wire reinforcement-which is unique and new; and a horizontal device such as the placement nozzle 134 of FIG. 2, or the crab nozzle 130 of FIG. 8, can be outfitted to lay horizontal wire reinforcement. Layer 3B can be divided into two layers of placement, one for vertical reinforcement, and one for horizontal reinforcement.

Whenever reinforcement elements, whether preplaced or simultaneously-placed, can be avoided with the simpler inclusion of fibers within the cementitious mixture, nothing in the present invention prevents that practice—it is all easier. Avoiding reinforcement reduces steps and increases speed, obviously. The problem is general acceptance of the practice by Building Officials, lenders and insurers—with acceptance of seismic performance being the highest hurdle for “fiber-only-reinforced concrete.” These (sometimes political) factors are out of the control of any inventor, and so including reinforcement must be dealt with as a physical design problem to be solved.

Layer 3C, or a finish layer, can be placed with a plaster tool such as 5T, though it can preferably also have the adjustable width restriction of 5W. This finish placement sequence should include the downward-moving smoothing pass, so that the wall brace cannot as easily use the material placement system motion-control. However, depending on the degree of set of the internal layers (3A and 3B), the wall may not need any bracing at this point, so wall bracing system may not be needed. Layer 3C, or a finish layer, so in lieu of concrete, it can be made with a plaster mix, to make a smooth finish easier. The distinction between the source of material being 98 or 130, is essentially that 130 contains coarse aggregate.

This layered placement can also be used for the cladding: Most material can be placed in a layer with a toothed tool, using only the upward motion for placement, so that wall bracing can be simplified (This can then be done for two or more layers on the concrete side). Later, after these “rough” layers have set enough (or even set hard), so that wall bracing is no longer required, the smooth layer can then be placed inside and out using a smoothing tool but not needing the wall bracing system. With this scheme, only the simpler wall brace system (controlled by the vertical placement system) is required.

And, if two of vertical placement device 5 are employed simultaneously, with one on each side of the foam wall 1. If one of them is applying the plaster coat 2 while the other is applying the first concrete layer 3A, in mirrored, simultaneous, balanced, motions, then temporary bracing of the foam wall 1 is not required, because there is no net out-of-plane force applied to the foam wall. And for subsequent placements 3B and 3C, made after the first placements have set up, will not require bracing as now the wall can be substantial and stiff enough to accept placement on one side without detrimental deflection. This procedure avoids the need for bracing the walls, and so avoids the need for any version of system 206. Instead, there must be two of member 14, one for each tool 5; or member 14 must be of two linked, vertically-oriented elements that work as one. In either case a length of a “mirrored” 14 is shown as 14M. The material placement systems controlled by member 14 and member 14M each require their own corresponding supplies of plaster 98 or concrete 130, for their own vertical placement device 5, of whatever version may be appropriate.

### FIG. 13

The vertical placement device 5W allows adjustable width confining of the material flow, so that material placement can coincide with required widths for a given project. The width can be confined from one side of the nozzle or the other, or both. The reason for providing a confinement mechanism to both sides is that, with this embodiment, the elements that confine also project outward from the side of the tool, and this can be an interference problem at inside corners of walls. If that final pass requires width confinement, it can be done with the mechanism at the edge away from a perpendicular wall. Otherwise, to achieve more width reduction, both restricting devices can be utilized. This feature can be on any of the vertical placement devices disclosed herein. The device shown here has the optional teeth for grooving a surface, and so is labeled as 5G. This feature can also be on any of the vertical placement devices disclosed herein. Please note that the upper image of device 5W, viewed from the back, is simplified for clarity, in showing the device to be level rather than sloped as it really is.

A width restrictor 179 serves as the side plate of a placement device 5W. To restrict the width of material flow, it is pushed by an actuator 112 at its tail 179, so that it is rotated into the device 5W, over the bottom plate, reducing the material flow width to W′. Most of the side is left open, so that when restrictor rotates back to normal position, material that found its way to the outside of it can be expelled rather than trapped. The overlap with side plate 107 can be minimized, or eliminated, as necessary for this purpose. The side plate 115 an be tapered and inset to a pivoting surface of restrictor, to minimize any particles getting stuck at that gap. The taper of the device top plate 103 relative to the bottom plate 95 does not hinder the restricting motion of 178, but the retracting motion can be hindered if particles are then over the top of it. This is another reason to leave the side open as practical, so that any such particles can be cleared. The nozzle terminus 102 (in foreground of the lower image) can preferably have the curl (shown in FIG. 11) that occurs beyond the reach or restrictor, so that its necessary taper is minimized.

The toothed edge 230 is shown as an attachment to trowel plate 106 in that it is a wear part that will need replacement. The grooving pattern can vary considerably, though as it will wear, starting with an exaggerated profile is warranted. It can be of hardened tempered steel, of thickness necessary for stiffness between fasteners.

### FIG. 14

This shows a downward-view-section of the crab nozzle 160, showing rotation angle R, pivoting the nozzle away from the direction of its movement. The position and angle are such that a leading edge 164 is located within the (future) concrete wall plane, following a line 168 that is deemed to be clear of reinforcing members 10; and a trailing edge 165 is following a line that defines the concrete face 170. Leading edge 164 and trailing edge 165 are identical, except for their orientations with respect to motion, rotation and position relative to the wall. When crab nozzle 160 reverses direction and mirrors the rotation, their roles reverse. Each of a side plate 162 has curvature that is preferably increasing toward the discharge, so that the confinement pressure rise fills out the flow at discharge. This geometry also provides a tangent line at each side at the discharge that is beneficial, in that the leading edge 164 can better deflect any interference with potential obstacles, and the trailing edge 165 is more square to the finished concrete surface, cutting that plane more clearly. The pivot location is shown conveniently coincident with the pipe providing the controlled flow of concrete 130, but this is not required. A bottom plate edge 166 is preferably of an arc radius matching that pivot, so that as the crab nozzle rotates to the mirrored configuration, the edge 166 clears any reinforcing elements 10, yet is as far as it can be within the plane of the concrete wall. A top edge can either match this curvature or be back away from it somewhat. That is the purpose of the crab nozzle, to beneficially project the placement of concrete at far into the plane of the wall as is possible, while also screeding off the surface of the wall, and doing this with only a rotation.

The crab nozzle 160, as shown, does not have a confining plane (such as the screed plate 134 of FIG. 2), and so its use cannot be combined with significant vibrational consolidation means, the concrete placement rate will be relatively slower, and/or each lift must be smaller. This is not intended to be used with high consumption rates of concrete, such as would typically be delivered by mixer-trucks. However, it is a means of using a simple rotation motion to improve the projection of concrete material within a wall plane when placement is from the side, while also defining the outer surface of that wall plane, so allowing improved digitally-controlled additive-manufacturing of concrete with pre-situated reinforcement.

### FIG. 15

A wall tie 7F that has integral furring can be used to position the mesh 8 a controlled distance from the surface of the foam 1. Tie 7F is shown to be inserted from the plaster side of the wall, and so is preferably installed at an upward angle toward the interior side of the wall, for reasons stated previously. The tie inserter of FIG. 7 can be used for this purpose. When tie insertion is from the exterior side, the waterproofing layer 9′ can be of sheet material, in that the ties can insert through it into the foam. As this process can be machine controlled at controlled locations, these tie locations can be utilized to establish the locations for rebars 10; in this case locating a horizontal bar shown in section. The tie hook 75 can have a longer tail, to enable then tying the rebars in place at locations defined by tie placement.

The hook 75 not inserted into the foam, is one having a mesh seat 176, whereby the mesh is secured by dropping it into the hook 75, and in front of seat 176. As the tie is already tied to rebar, it can hold the weight of the mesh. Examples for tie material include using non-tempered or lightly tempered galvanized or stainless steel wire of from about 20 gage to 12 gage (0.9 mm to 2.6 mm), or a resin composite material, such as fiberglass molded to the shape shown, using a polyester resin. For composite material options, the tail 74′ can be made stiff enough so that the it will position and hold the rebar 10 into place without tying the end, or that tail can be not saturated with a resin, so that it can be tied onto rebars using a hitch knot.

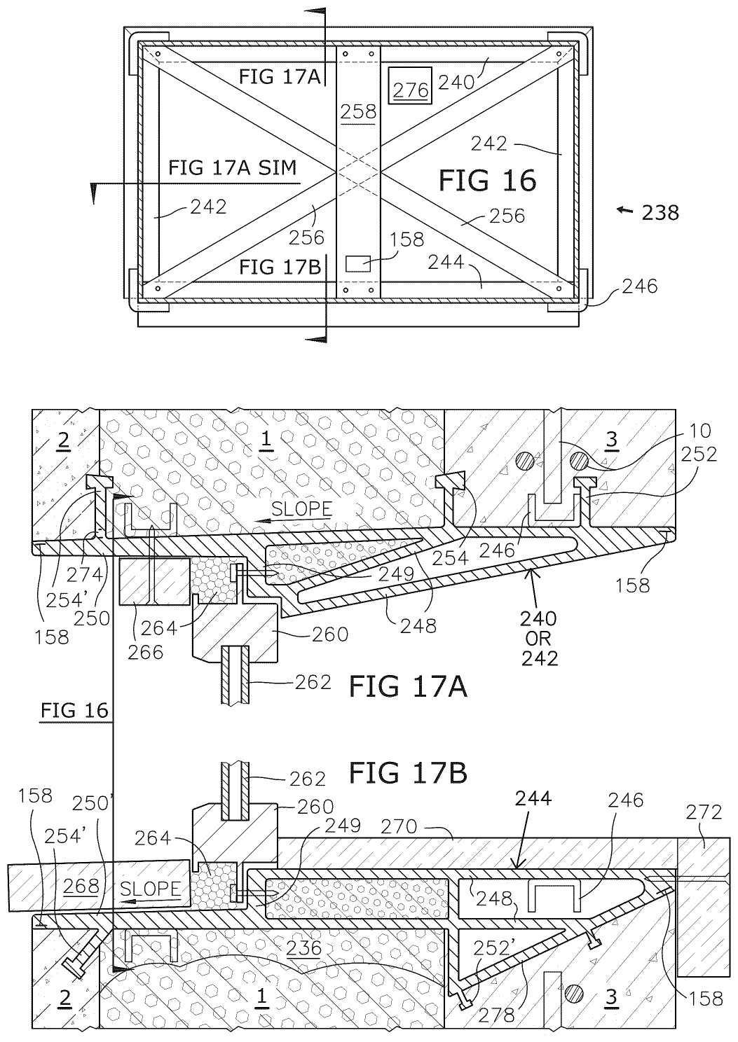

FIGS. 16 though 18

These show a new concept for window installation in building construction, where in lieu of constructing an oversized “rough opening” into which a window is installed, then flashing the wall, sealing and trimming—to accommodate the differences between wall and window frame, a “precise frame” is manufactured to match a given window precisely in all respects, and then it is foamed into place to its precise location (during the foam wall construction process), so that a window can be simply installed into it. This has particular advantage for digitally-controlled construction, in allowing the machine-controlled processes actually complete the construction to a more finished state, rather than only take it to a rough state, where an indefinite amount of skilled labor is required to flash, install and trim window installations. Furthermore, digitally controlled additive manufacturing processes require support anyway, if material is placed over a window opening, so that a lintel member or the like is required for support of that material-which must be installed before the additive manufacturing can be completed. The thinking here, is why not just install an entire frame (also known as a window buck), so that the manufactured window can be easily and precisely installed later, except make it accurately-specific to that window, thermally efficient, waterproof (no flashing required), and fireproof.

### FIG. 16

This shows a front view of a precise frame 238 before it is installed. This view is at a cut partially into the frame for clarity. Please see FIGS. 17A and 17 B for the cut location of FIG. 16.

It is important that the frame is precise in all 3 dimensions. It must be of the right dimensions, “square”, and true to plane (without warp), as this frame needs to precisely fit the window. The frame can be used to accurately position the window installation, it can also be used to define finished wall surfaces, and it can provide all of the necessary weatherproofing for the window installation. One reason for using the precise frame is that the 3D-print process needs a lintel, or some kind of supporting surface, for printing material over windows and doors, regardless. So why not make the effort of installing the support be a lot more useful to the finished product?

A lintel member 240 is mitered to two of a vertical jamb member 242, which both fasten to a sill member 244. The frame can have its corners secured with one or two of a corner brace 246, which can each be a steel channel bent to a square corner. Diagonal corners are tied with a diagonal brace 256, each fastened at the plane of the (future) window attachment, or the like. One or more of a lintel support 258 are included as needed for a given temporary loading condition, and depending on the strength of the frame members. An RFID tag 158 or bar code target can inform the digital construction system where the frame is to be installed. Two of a lift aperture 276 (only one shown) should be provided to allow digitally-controlled installation. Locations of cuts for FIGS. 17A and 17 B are shown.

### FIG. 17A

This is a detailed section view of the installed window head, and with very minor differences, both window jambs. The lintel member 240 is hollow or foam-filled as is possible, to minimize cost and heat transfer, while still performing its structural role. So it is made up of a web element 248 as possible. The material is fiber-reinforced resin-rich cementitious or (aluminum trihydrate) fireproofed resin (polyester or epoxy, or the like. The cementitious version can be ceramic, geo-polymer, or ultra-high performance cementitious “resin” and can be with a layup of fiberglass, basalt, Kevlar, or these types of fabric. It must be waterproof enough and UV resistant enough to avoid long term damage in use. The member is economically of a continuous section extruded or pultruded. To provide anchorage into the concrete (and shear transfer with the concrete), an anchorage strip 252, or the like, as part of the extruded section, is provided. For anchorage with foam and with concrete, a dovetail anchorage strip 254 is provided, where the dovetail-shaped head is made to anchor permanently into the concrete. This strip, along with strip 254′, help in providing confinement for the foam placement and in presenting a level pair of “rails” for the foam former to set upon—in that the top surface of member 240 is sloped to the exterior for drainage. Strip 254′ has a series of holes to let water though (not necessary on the jamb members). One should always assume water has entered a wall assembly, and that it needs a path to the exterior.

This particular design is for installation of a common inexpensive flanged window frame 260 for support of dual-pane glass panel 262. Of course this can vary. A thick web element 249 is made to accept screw fastening of the window flange for wind loads, where the load path of web elements transfers that force back to the concrete, via the strips 254 and 252—and also tying the plaster 2 to the concrete wall. An optional trim 266 (preferably of inert material) fastens to a plate element 250, over insulation fill 264. Both the exterior and interior edges preferably have a series if RFID tags 158, so that these edges can be located for frame installation, and subsequently for definition of wall finished surfaces. Two of the corner bracket 246, at the corner beyond, are included to show an example profile for the part.

The interior visible surfaces of these members are angled away from the window opening as possible, to improve view and light access to the interior, as this is generally preferred. As these can be entirely finished surfaces, the frame can be supplied with a protective covering material, that is later removed. The window frame can be installed with a gasket or into caulking, or the flange/fasteners can be taped over, to prevent infiltration.

### FIG. 17B

The sill member 244 cannot just mirror the lintel (head) in that it also needs to drain to the exterior; the sill's plate element 250′ slopes down to the exterior, so that water behind/under an optional sill trim 268 can get out. Sill trim is preferably inert material. The sill interior is more useful in serving as a level shelf, though it is more likely to get damaged during construction, so is shown with an optional subsequently installed sill trim 270 and interior trim 272. A web 278 is sloped as this reduces a tendency of creating voids in concrete 3, when placed from the side; and the anchorage strips 252 are smaller for this reason. Both the vertical surface, created by the slope of 278, and the angled strip 254′, help to confine foam placed below sill member 244.

Sill member 244 provides temporary support for the frame 238, and this is provided by placement of filler foam 236 that goes into the temporary void between foam wall 1 and frame, as it is held in place, discussed below.

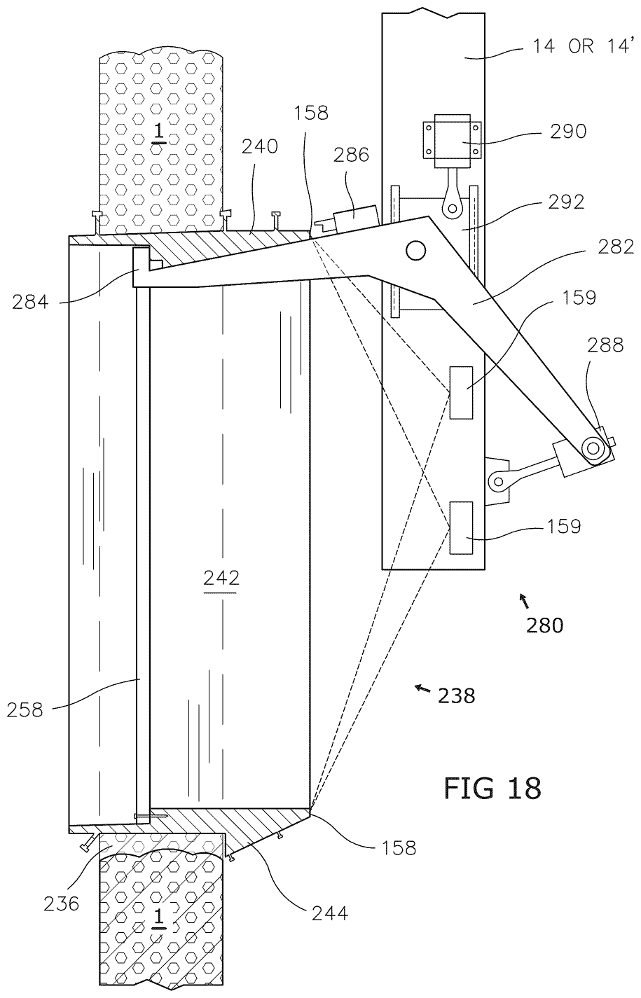

### FIG. 18

Frame 238 is installed into foam wall 1 with a frame setter 280. One or both sides of the window opening have foam placed, so that the frame 238 can be attached to the building, into the oversized opening created by the foam former. The gantry system directs vertical member 14 so that setter 280 locates the frame to an opening, lifting it by the lintel member 240 with two of a lift arm 282, and securing it with two of a pneumatic clamp 286 (shown open for clarity), pushing member 240 snug to stops 284; with the clamp bearing surface being sufficient in size, along the frame edge, to prevent damage to that edge. Setter then positions frame exactly where it needs to be, according to the digital model, and location information provided by RFID tags about the frame edges, to a linked array of the RFID readers 159. Stereo algorithms are employed to accurately determine the planar location of the frame edge. Alternatively, capacitive, ultrasonic, infrared, or similar proximity devices can be used in the same way for relative location information. Lift arm 282 is rotated by actuator 288, which can be a motorized ball screw, in order to adjust plumb (vertical) of the frame. Similarly, actuator 290 adjusts plate 292, for one arm 282 pivot, so that frame transverse level can be adjusted precisely. Bearings for arm pivot can be elliptical or centering/pivot for this very slight amount of lift action to one side.

Filler foam 236 is placed below and alongside the frame. For the time being this is a manual task. Foam for this purpose must not have an expanding force that would affect to positioning of frame (while it is held by the setter), nor the straightness of frame members. As soon as filler foam has set up, the setter can release from the frame, and move on to place the next frame. This frame is now ready for foam placement above it, and it can subsequently support both plaster and concrete layers. One lintel support 258 is shown in the plane of the future window, or of a future glass pane, but this support can be augmented by additional such members, as needed for subsequent material placement above the frame. As the frame 238 positioning is more critical than the foam 1, in that it defines finished surfaces of the wall, so bracing of the frame, rather than the wall, during plaster/concrete placement, can be a more effective means to assure accurate completion of the wall. For a series of window frames, planar alignment with each other can be the most important than alignment issue for establishing trueness of a wall.

The frame 238 is also a helpful concept for door openings, where a recess can be provided for the frame of a pre-hung door assembly. A temporary member can serve as the “sill”, to keep both jamb members parallel. Alternatively, as the frame 238 is precise and square, it can be what a door is hung to directly, without shimming, etc.

An alternative cost-effective embodiment is where the frame 238 is manufactured for accepting window glass directly—such as a dual-pane window glass unit. In other words, the frame 238 itself is the only window frame, with the glass installed after the concrete and plaster placement has been completed—or whatever may be the most opportune time to install windows. This arrangement has the advantage in that the (most common) vinyl frames can be omitted, so avoiding that fire hazard-because the low-melting-point vinyl material melts out during a wildfire, allowing the glass to fall out, so exposing the interior of the house to the wildfire (even when tempered glass is used to avoid that very problem). This system allows use of a fireproof window frame that is thermally efficient, and that efficiently embeds directly into the concrete wall. This is the window frame, and because that because it can be placed before the concrete, it can be partially cast into concrete during the concrete placement, efficiently anchoring the window against high wind loads, even where the window-glass plane does not align with the plane of concrete. The snap-in-place keeper-strips—that commonly secure window glass in their frames—can be duplicated with this frame, in lieu of fastener-attached keepers. Drain ports to the exterior are beneficial for removal of accumulated water.

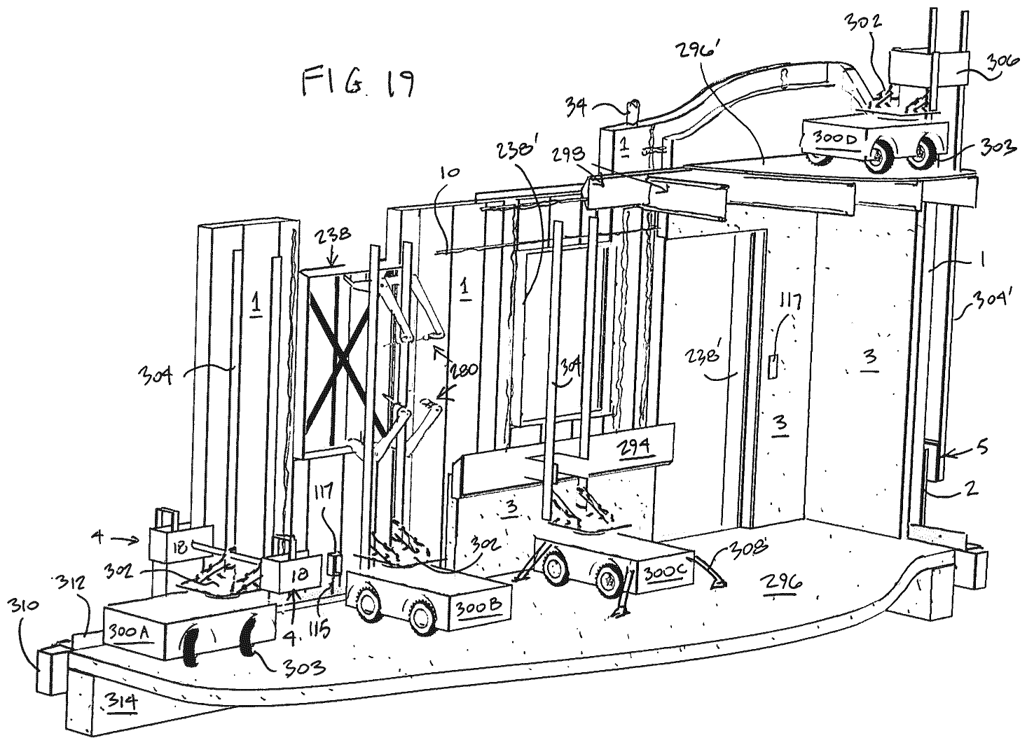

One set of the frame setter 280 is shown, clamped to the upper member of the frame 238. This can preferably be two sets of the setter 280, clamped to both the upper and lower members of the frame, as shown on FIG. 19.

### FIG. 19

This example of a construction process shows several of an autonomous mobile platform (AMP) 300, each taking on a different task. Material supply hoses are omitted for clarity in this condensed view. On a real job, these tasks would not necessarily be this condensed, but the foam and window frame placement is essentially a coordinated single process, made possible by the adjacent-vertical placement of foam. This process can require human intervention, for such things as squirt-foaming window bucks into place, installing rebar and/or utilities; or automation can be arranged for all steps involved, using known arts. Integrating humans is not a problem; safety issues of human/robot interaction have been worked out, such as with the system disclosed in patent application U.S. Ser. No. 14/660,259, “Systems and Methods to Facilitate Human/Robot Interaction”, filed by Amazon Technologies Inc, on 2015 Mar. 17.

A floor 296 is in place, serving as a plane to allow positioning of each AMP 300. These units are posed as a simple example of a mobile robotic means to accomplish the necessary tasks; there are many existing robotic systems that can serve this purpose. In this case, each such platform has 4 of a unidirectional powered wheel 298, and a rotating frame 302 attached by a ring gear, as is common with robots. Two of a mast 304, removably attached to the frame, each providing a linear axis for an actuating system. The masts are oriented vertically by actuators on the wheels or on the ring gear, or by a set of an actuated support 308. Positioning of attachments to the masts can be gps/gnss, measurement to established reference points that are measured by RFID tags or a lidar system, or an initial system. The present invention is about using existing digital control technologies, whatever they may be now or in the future, to build these new wall assemblies, not to invent new robotic/attachment positioning systems.

AMP 300A is slip forming spray foam, with two of the foam former 4 articulated by the masts 304. Two foam formers are used so that the process can approach from the right or the left. Alternatively, a single foam former can be articulated to aim either way. Wall tie placement is not shown here, to simplify this drawing. AMP 300B is holding a precise fit frame 238 in position as foam is placed around it. After the frame is effectively glued into place, AMP 300A can finish forming foam over the top of it. Meanwhile AMP 300B can retrieve the next frame, which is identifiable by attached RFID or bar code or QR code, informing the robot where the next frame is to be positioned, in order to be foamed into place. Utilities are installed, such as romex wire 117 or electrical box 117 or pipe 34; and any membrane installed, following foam placement, and before concrete placement. A given wall can have many frames, one frame, or no frames. What is most important about the geometry of a wall, is that the premanufactured elements, especially those with moving parts-such as doors and windows—are positioned properly. So giving this priority by doing it first, then casting concrete up to it, is the most effective way to accomplish it. Other parts of a wall finish can vary, intentionally or not, with little problem, but the doors and windows need to function properly. Conventional 3D printing, where rough openings are printed and then doors and windows fitted and flashed to those openings is about the least efficient way to construct such a wall assembly.

AMP 300C is controlling a slip form beam 294, is as disclosed in U.S. Patent Application Ser. No. 63/338,032, “RAPIDLY-DEPLOYABLE AUTOMATED WALL-CONCRETE PLACEMENT SYSTEM,” to Michael George BUTLER, filed 4 May 2022, reference numeral 30, is compatible with the present invention. Any of the concrete placement devices disclosed in the previous provisional patent application, associated with the beam 294, can be suitable here. If clearance with a pre-situated floor system 296 is a concern, then the correspondingly compatible system should be employed. As the total loading from beam 294 is higher than other applications for the AMPs, then a set of the articulating support 308 can provide bracing, or mast attachment can be made to a floor system 298 above, or other aspects disclosed in the above referenced patent application. Also, elements of framing of the next floor system 298, can be placed before concrete, in order to brace the foam wall, also per the above referenced patent application.

After wall concrete placement, the floor system 298 can be completed, and a floor deck 296′ installed, providing support for AMP 300D, which can use movement control in a box frame 306 to reach down the outside of the foam with two of a lowerable mast 304′, in order to apply stucco 2 from above, using any one of the vertical placement device 5. As AMP 300D is working against leverage by geometry of the long reach, device 5 would be relatively small, such as only half or a third the width of a typical meter-wide rendering machine. Alternatively, the braces 308 can be employed, or the extended masts 304′ can be temporarily attached to the wall exterior, typically of the floor below, or the foundation in this case. The same robotic system can be utilized beforehand to apply a waterproofing or moisture control barrier, as may be needed or preferred.

While not a preferred method, where budget dictates purchase of only a single (expensive) robot, a single AMP or other type of articulating mobile robot can be used for this wall construction process. In this case, the frame 238, shown held in position by AMP 300B, can be foamed into place by a human, then that AMP switches back to slip forming foam until it is ready for the next frame, and so on. Of course, using a cooperating set of mobile robots is far preferable, and allows more complete automation with some human intervention, and also can allow the construction process to be entirely automated.

### More Disclosure on Admixture Composition for Rheology Modification of Concrete

The placement of wall concrete rapidly enough to be practical for the presently disclosed construction method, without confinement of forms or pneumatic spraying, requires significant modification to a typical mortar or concrete made with ordinary portland cement. In particular, to place concrete fast enough to justify truck-delivery of conventional ready-mix concrete, one should be able to consume a truckload of concrete within about an hour. Even if a truck is only half-full, such as with about 5 cubic yards or 4 cubic meters of concrete, placement for a 4″ (100 mm) thick wall would require placement of about 45 square feet or 4 square meters, within an hour. This may mean a vertical build of a half meter, in an hour. Most contemporary concrete 3D printing operations can place at only a small fraction of this vertical rate. Concrete modified with the improved rheology-modifying admixture of the present invention, vertical rates of a foot (30 cm) per minute can be achieved. This means that with this new admixture concept, the typical 8′ (2.44M) tall walls of a conventional dwelling can be printed within an 8-hour day, utilizing a conventional concrete made with ordinary portland cement, for example.

Even for site-batched concrete or stucco consumed at lower rates, inline modification dramatically improves the process, by making placement faster and more robust; and this improved admixture has a phenomenal effect on minimizing or eliminating visible shrinkage, which is really the primary quality issue for concrete, stucco, and 3D printing of various cementitious materials.

This thickening or rheology-modifying admixture, here referred to as “admixture,” is that intended for inline modification of concrete, such as with an inline mixer, where a proportional amount of the admixture is injected and intermixed with concrete, a suitable distance before discharge or placement, as disclosed previously by the present inventor. The term “concrete” is to mean any type of a cementitious mixture, normally using Portland cement with aggregates, but that could be any type of a water-based mixture that “sets” into a solid material. The admixture developed provides thickening to anything aqueous, so it is not specific to thickening concrete or Portland cement. For the modification of any cementitious mixture, no other liquid admixture has a as much of a concentrated effect as does this admixture; that is a combination of a gelling effect on a cementitious solution with a thickening effect on an aqueous solution. This liquid admixture has more effect on concrete, per unit mass or volume, than any other, so that it can modify a normal low-cost concrete to become a 3D-print media, at a dose of 0.25% of mass of concrete. The necessary dose can range from around 4% to 0.01%, or even less, depending primarily on the w/c ratio of the concrete; but also on the mix design, the desired build rate, any retardation of the cement, etc.

The improvements to the admixture involve various means to strengthen its concentration, allowing increased thickening with a lower dose, with more beneficial rheological effects imparted to the concrete, so that thickening with extreme shear thinning is possible. This is known as pseudoplastic, a Bingham pseudoplastic, and as thixotropic: a fluid that gets thinner (less viscosity) when under a higher rate of shear. More specifically, this is a Bingham rheology, having a very high yield point, but with a plastic viscosity that reduces with a higher shear rate. With the influence of the admixture, this shear thinning is possible, even after the cement has started to set. The thickening admixture components can be proportioned to adjust the amount of thickening provided by aqueous-phase binding, cement particle flocculation, false set of the cement, gelling action, fluid structurization, and/or acceleration of cement hydration. Preferably the different components are each providing thickening or thixotropic benefit by various or distinct means, and initiating their own effect at different stages in the process. This allows a more complete rheology, with a controlled, less sudden, creating a more gradual increase in the modification or thickening process.

The organic thickeners include natural polysaccharides, modified biopolymers, and synthetic polymers. Natural polymers include starch and natural gums. Modified polymers include decomposed starch and its derivatives; cellulose-ether derivatives, such as hydroxypropyl methyl cellulose, hydroxyethyl cellulose, and carboxyl methyl cellulose; and electrolytes, such as sodium alginate. Synthetic polymers including those based on ethylene, such as polyethylene oxide, and those based on vinyl, such as polyvinyl alcohol.

These polymers are commonly used for composition of Viscosity Modifying Admixtures (VMA), also known previously as Viscosity Enhancing Admixtures (VEA). These are primarily utilized along with a high-range water reducer to obtain a highly fluid, yet cohesive, cement-based material that can flow readily into place, with minimal separation of the various constituents of different densities, and minimal intermixing with the surrounding water whenever cast under water. The term VMA is often used to indicate an agent that minimizes concrete particle segregation, though the goal for these admixtures generally is often to maintain a higher slump.

A Rheology Modifying Admixture (RMA) is similar, but is intended more for improving workability of a lower-slump concrete. While these admixtures have similar components to the present thickening admixture disclosed, they are not nearly capable of modifying a normal pumpable concrete to become a 3D-printable mix by admixture injection, for example. They are not formulated for this purpose, but for generally the opposite purpose—that of maintaining a high slump but without segregation. Even if intermixed with normal concrete at a very high dose, these liquid admixtures will not provide a sufficient increase in plastic yield point for 3D-printing, because they themselves all contain water in sufficient quantity—such that the net effect at an increasingly very high dose begins to lower the plastic yield point, making the concrete less able to be stacked than without any of the VMA/RMA added. Where a VMA/RMA is in a solid form, of course it can thicken a concrete to lower its slump sufficiently for vertical stacking, but a solid thickening admixture cannot reliably be inline-injected and intermixed with a pumped line of concrete. What happens is that as the thickening solids make contact with wet material, they thicken immediately, causing blockages in the material flow. However, if the solids are conveyed into the concrete within a non-reactive liquid carrier, according to the present invention, then a fluid injection into a line of pumped concrete becomes possible, and the aqueous concrete paste or slurry must first displace the non-reactive carrying liquid saturating the solids, before the solids can react. This provides a beneficial delay to thickening action, allowing continued intermixing with highly reactive thickening solids, and an adjustable period of more workability (varied per admixture composition), facilitating completion of the concrete placement process.

Commonly used VMA/RMA in cement-based materials include polysaccharide polymers of microbial sources, such as welan gum; cellulose derivatives, such as methyl cellulose, or hydropoxycellulose. RMA may include acrylic-based polymers, such as partial hydrolysis products of a polyacrylamide copolymer of acrylamide; and sodium polyacrylate, or similar super absorbent polymers (SAP). These are discussed below. The mode of action of a VMA/RMA depends on the type and concentration of the polymer in use. Welan gum and some cellulose derivatives bind with the mixing water since long-chain polymer molecules adhere to the periphery of water molecules, thus imbibing and fixing part of the mixing water. These polysaccarides increase cohesiveness, not by binding to cement particles (flocculation), but by binding to the water phase.

Molecules in adjacent polymer chains can also intertwine and develop attractive forces, thus further blocking the motion of free water and causing it to gel and display increased viscosity of the concrete; however this type of thickening must be moderated if concrete pumpability is to be maintained, as this thickening can mimic a lack of water. Shear thinning properties help, in that the bound water can then be available for pumping lubrication.

Other thickeners, such as some cellulose-based water-soluble polymers, acrylic-based water-soluble polymers, and carboxymethyl chitosan (CMCH), work by adsorbtion onto cement particles. Where a HRWR water reducer, such as a polycarboxylate ether that works by steric action, is previously adsorbed onto the cement particles, it will interfere with this type of thickening action, at least in terms of maintaining a lowered yield point. So, this thickened concrete can still be somewhat self-leveling, which is counterproductive to a vertical build up. In general, water reducers will reduce the cement paste yield point, so are preferably not used at high doses. When water reducers are used for a low w/c, using thickeners that act by binding with available water will create an exceptionally pronounced thickening effect. In this case, precise dosing can be very important.

VMA/RMA active components are water soluble polymers such as, for example, cellulose ethers (e.g., hydroxyethyl cellulose (HEC), hydroxyproplmethyl cellulose (HPMC), sodium carboxymethyl cellulose (CMC), carboxymethylhydroxyethyl cellulose (CMHEC), and the like); synthetic polymers (e.g., polyacrylates, polyvinyl alcohol (PVA), polyethylene glycol (PEG), and the like; organosilicones, such as silicone resins, dimethicones, and modified silicones are used as rheology modifiers; exopolysaccharides (also known as biopolymers, e.g., welan gum, xanthan, rhamsan, gellan, dextran, pullulan, curdlan, guar, xanthan, locust bean, konjac, acacia and the like); marine gums (e.g., algin, agar, carrageenan, and the like); plant exudates (e.g., locust bean, gum arabic, gum Karaya, tragacanth, Ghatti, and the like); seed gums (e.g., Guar, locust bean, okra, psyllium, mesquite, and the like); starch-based gums (e.g., ethers, esters, and related derivatized compounds); proteins (e.g., collagen, albumin). These organic thickeners are sometimes called hydrocolloids, particularly where they make a colloidal gel.

The cellulosics (or cellulose-based modifiers)—CMC, HMC, HPMC, and others, all are chemically substituted cellulose macromolecules. The hydroxyl groups are what get substituted by other functional groups, such as methoxy or propyl. The amount of substitution and molecular weight determine viscosity of the solution, assuming concentration stays the same; adding more increases viscosity. The micro-fibrillated cellulose rheology modifiers available at present writing (such as Exilva by Borregaard, P.O Box 162, N-1701 Sarpsborg, Norway) are only in an aqueous liquid or gel form, so this limits their application to the primary embodiment here (of a non-water liquid admixture). There are three main varieties of carrageenan, which differ in their degree of sulfation. Kappa-carrageenan has one sulfate group per disaccharide, iota-carrageenan has two, and lambda-carrageenan has three. The iota and lamda types will activate in the presence of calcium ions, so provide thickening or gelling on contact with cement paste.

For purposes of the present invention, there is a big problem with all known VMAs, VEAs, RMAs, and other such liquid modifiers. This is that their maximum range of thickening is limited, so that a high-slump concrete cannot possibly be thickened sufficiently to allow a vertical build, such as 3D printing. With a concrete having a high water content, there is a point of run-away thinning, where an ever-increasing dose of these admixtures will simply increase slump, because they are water-based. This effect makes it impossible to sufficiently thicken a wet concrete (to allow vertical buildability), whereas with the present invention, the admixture can have no water, so that any increasing dose of admixture is not increasing the amount of water in the concrete, and so a high-water-content, or high slump concrete, can be transformed into a concrete that can be 3D printed and the like.

It is possible to use a change in pH (of a low-pH aqueous admixture) to enable a thickening effect of pH-sensitive thickeners, such as ASEs, HASEs. Also, a polyacid is a polymer that will respond to different pH values by swelling or deswelling, can be used. At a high pH, a polyacid releases protons to become negatively charged, so like-charged parts of the polymer repel each other, causing swelling. Super absorbent polymer (SAP) powders, such as PAA or PAM, can also be similarly pH-swelling. Many acrylic solutions are also pH thickening. However, these thickening mechanisms tend to be less robust than preferred for a heavy concrete material, and these thickening structures generally break down from the hysteresis of the intermixing process itself. Also, the continued shearing actions from pumping concrete is enough to further break down these thickening mechanisms; and at high dose they can make the concrete incohesive, impairing vertical buildability. In addition, the inclusion of water within a thickening admixture can be counterproductive to the intended goal, and some variations of these swelling thickeners will start to contract before the cement as set up, causing increased plastic shrinkage.

The concept of a water-free liquid admixture, for modifying concrete (or any water-based mixture) in a pumping line, to allow a rapid vertical build, as previously developed by the present inventor, has now improved in multiple ways. The concept allows introduction of water-reactive-thickening solids by use of a liquid-carrier that does not react with them, but serves as a medium of transport allowing a continuous intermixing process of reactive solids with concrete, within a pressurized line of pumped concrete. Material flow delivery to an inline mixing process is not practical with an admixture that is of a dry material, and use of a water-based liquid admixture cannot provide water-reactive solids at a high enough concentration to be sufficiently useful for vertical buildability. This is an example of where a water-reactive component can remain inert and unreactive in liquid form, suspended in a non-water liquid. When the non-water liquid is effectively replaced with water upon intermixing with a concrete mixture, or at that point the solids have access to water in order to react, the suspended solids then react to modify the concrete. Another benefit of a non-water liquid admixture is that the non-water carrier can provide an effective temporary masking of the thickening solids (a delay until full contact or sufficient contact for reaction with water or with cement paste), so that a substantial thickening action is not so abrupt as to prevent complete enough intermixing, or cause blockages within the inline mixer or remaining pump line. The water-reactive solids then begin to dissolve or react with water, as the water displaces the liquid they were previously soaked in.

Problems with the non-water-liquid concept include a tendency for suspended solids to separate from the liquid without the inclusion of an emulsifier and/or stabilizer, and for the admixture itself to solidify without inclusion of an oleochemical liquid or the like-which would also require an emulsifier to slow the separation of that lighter liquid. These effects relate to the specific base liquid utilized, in that some primary solvents have more of these problems than others; and the problems relate to the particular suspended solids utilized. Unfortunately, most solvent or carrier liquid bases tested, as well as most emulsifiers and stabilizers, have detrimental effects to concrete, such as interfering with cement hydration, potentially or actually weakening the concrete. The goal was finding a low-cost non-toxic low-volatility primary solvent that itself did not negatively affect cement hydration, and would provide a long-term stable base for the admixture, with a very low proportion of, or not any, detrimental stabilizers, surfactants, oils, or oleochemicals.

After years of experimentation with rheology modifying admixture compositions and their effects on concrete, it appears that many organic solvents can serve the purpose of a non-water liquid carrier. The organic solvent performance issues are ideally to be of low flammability, low volatility, low toxicity, low cost, non-hygroscopic, and no significant detrimental effect on cement or concrete. Also, the liquid carrier is preferably miscible with water, or dissolves sufficiently in water to liberate the water-reactive solids into the water. If the liquid carrier does not dissolve in water, such as an oil used for waterproofing concrete, it can function as a liquid carrier, though at least some reactive-solids will remain coated with the oil, and so not liberate into the water to react with it, or react with the cement hydration process. For utilization of the reactive-solids, the dissolution into water is preferably greater than the proportion of liquid carrier to water. For example, if a carrier liquid will dissolve into water at a 20% concentration (in the cement paste high-pH environment), then less than 20% of the liquid should be included relative to the water in the concrete, for solids dissolution, if perfectly mixed. As the dose of admixture is usually less than 2% of the water in the concrete mixture, a liquid carrier that dissolves at only around 6% or more in water, can allow sufficient reactive-solids dissolution in the water under realistic concrete intermixing conditions. The delay caused by the liquid carrier dissolving in the water, particularly the delay caused by the process of the water replacing the liquid carrier saturating the surfaces of the water reactive solids, helps in completing the intermixing process and providing more workability to the concrete before final placement, as noted previously.

If the carrier liquid is hygroscopic, it can absorb atmospheric moisture, swell the suspended solids in stored admixture, and thicken it so as to be unusable. This does not rule out hygroscopic carrier liquids, such as glycerol, however this type of admixture must be sealed from sources of moisture, or it must be batched anew essentially upon demand. An admixture that is hygroscopic will have that additional thickening action—in slowly absorbing some water from the fresh cementitious mixture, but the negative effect on shelf life may offset this benefit. The same effect is true for included solids that are hygroscopic, such as hygroscopic salts, in that such an admixture composition should be stored in a sealed container.

Liquids that can work as the liquid carrier (though not each meets all ideal performance criteria) include the glycols, glycol ethers, dialkyl ethers, glycol esters, or combinations thereof. This can include propylene glycol (a shrinkage reducing agent), polypropylene glycols (low molecular weight, such as around 400), dipropylene glycol, polyethylene glycol (molecular weight below 800), ethyl formate, or an alcohol such as glycerol, etc., or combinations thereof. The liquid carrier can be a shrinkage reducing agent such as di or tripropylene glycol methyl ether (tripropylene glycol monomethyl ether), di or tripropylene glycol normal butyl ether, propylene carbonate, diethylene glycol butyl ether, tetraethylene glycol, etc., or combinations thereof.

To date, a propylene carbonate liquid base was found to perform required functions and have the benefits for this purpose, without significant detriments. Also, this liquid provides a nearly immediate gelling of portland cement slurry, in developing a temporary gel-network and/or structurization of the unhydrated cement slurry. It flocculates cement particles, creating a network structure that is highly shear sensitive, and so can be reversed. Propylene carbonate has a detrimental property for conventional concrete placement in having a net thickening effect, so it never attained any commercial viability for this reason. However, for vertical buildability, net thickening is no longer a detriment, it is an asset. This thickening gel structure is broken down by agitation or vibration or other application of a high rate of shear, yet it will reconstitute itself, repeatedly, thus, creating a strong shear-thinning thixotropic effect. This liquid base can be of low viscosity at most any jobsite temperature, allowing a greater concentration of suspended solids, while remaining of a low enough viscosity for facilitating the pumping of the thickening admixture, such as with piston or diaphragm pumps. The degree of benefit that propylene carbonate provides for this new purpose is profound, and was really unexpected.

A problem still remained, in that, because of being a low viscosity base liquid, the suspended (non-reacting) solids would separate from the liquid during shear forces from pumping the admixture, and from frictional forces of passing through a small aperture. This separation would cause a buildup of solids that would cause blockages at fittings (choke points) of the pumped line, and also would cause separation of solids from solvent within the pump head itself. A sufficient proportion of a surfactant or other stabilizer could prevent this effect, as noted above and per previous disclosures by the present inventor; but then an oleochemical or the like would also be necessary to help prevent the surfactant from slowly reacting with the solids (causing excessive thickening of the stored admixture). A viable modifying admixture could be formulated without inclusion of detrimental components, but the shelf life (to date) would always be too short for commercial viability. Such an admixture would need to be formulated at the jobsite, and then consumed at the jobsite, or the like. While this is viable, it is not preferred.

Another problem with a low-viscosity solvent, also in having a density near to that of water, is that the most of the (non-reacting) solids drop out of suspension. This can be so immediate, that the admixture would have to be constantly mixed-even while it was being pumped, even with stabilizers included, or the pump line would pick up mostly solvent, then leaving so high a concentration of solids that subsequently the pump line would block.

With the goal of removing detrimental components, what was later discovered is an improved stabilization by inclusion of a high proportion of very-high-surface-area nano particles (such as fumed silica, which is beneficial to concrete durability) increases the liquid-carrier apparent density, so providing relatively increased buoyancy for the thickening solids and preventing or delaying their settlement to the bottom of a container, and in creating a sol—reducing their tendency to separate out during shear forces and friction from pumping action. Fumed silica is generally estimated to have a particle size in the 5 to 50 nanometer range. As a preferred solvent will accept a very high proportion of a high surface area fumed silica, or the like, with relatively little viscosity increase, particularly a fumed silica that is hydrophobically or lubrication-agent coated. The nano particles stabilize and densify the resulting liquid, so as to improve suspension of the larger solids included. The hydrophobic coating provides lubricity to the admixture, actually decreasing the admixture viscosity, allowing a higher concentration of solids (than with no fumed silica included), so providing clear benefit; though a too-high dose will offset the proportion of other solids that can be included without making the admixture too thick. The amount of hydrophobic fumed silica that an be beneficial ranges from about 0.1% to about 33% by mass. As fumed silica itself is an effective concrete rheology modifier, formulation flexibility is available with respect to the fumed silica proportion replacing some of the other thickening solids. As the silica nano particles act as nucleation seeds for hydration, an admixture that is a combination of only, or essentially only, fumed silica in a liquid carrier of propylene carbonate, at a high dose can also act as an extreme accelerator.

An example for a fumed silica with a very high surface area, can be a hydrophilic version supplied by AL2Chem; the FS-400, having a BET surface area of around 400 square meters per gram, and a dry density of only 4 to 5 grams per liter. A hydrophobic example is the FS-900, having a lower BET surface area of about 130 square meters per gram, but the hydrophobic coating allows a much higher concentration in the admixture with less admixture thickening than a hydrophilic. The hydrophobic coating in this case is dimethyldichlorosilane. It could also be polydimethylsiloxane, hexamethylsilazane, monomethyldichlorosilane, or octamethylcyclotetrasiloxane, and so forth.

The appropriate dose of such nano particles provides for an effectively higher, more stable, concentration of other suspended solids, for practical use as an admixture material, and to provide a long, useful shelf life—where the admixture is stable enough for its intended application, and where this can be accomplished without use of any surfactant, oleochemical, or other chemical means. Pumping of the very-high-solids admixture becomes trouble free. This improvement also means that all components can be ones beneficial to concrete, while the admixture has a very good shelf life. The primary remaining detriment to this shelf life is the suspended solids absorbing moisture from the air (as the admixture is very reactive to water), so storage in a sealed container is beneficial, and other agents can slow this process.

Extensive testing of various liquids and suspended solids has resulted in an admixture composition that essentially prevents plastic shrinkage effects, primarily because of years of selecting for solids that do not increase, and/or that reduce, and/or compensate for, plastic shrinkage. These solids can also provide internal curing—to help compensate for the lack of proper curing from an additive-layering placement process without forms; the internal curing also reducing shrinkage. And because of early strength gains, the preferred admixture composition provides very-early strength before plastic shrinkage forces occur-so that there can be no plastic shrinkage effects (visible). The beneficial effect of crack-reducing fibers included in concrete is enhanced, in that because of the admixture, the fiber bond strength is developed very much earlier, before plastic shrinkage has begun; the new admixture creating a new sequence in the concrete curing process. Repeated testing has shown that these admixture compositions can effectively eliminate visible effects of shrinkage that are visible in control samples, and in combination with the addition of high strength fibers, the admixture can eliminate visible cracking indefinitely.

This lack of shrinkage compares favorably to nano clay types of rheology modifiers (such as an exfoliated magnesium aluminosilicate, attapulgite, or sepiolite clay), which if used solely at a sufficient dose to allow 3D printing of most cementitious mixtures, will normally increase shrinkage considerably and unacceptably. However, at a lower dose, such a nano clay can be a beneficial component of the present admixture compositions; where the liquid carrier can serve as an effective delivery vehicle for this, or any other suitable solids component, such as a shrinkage compensator in powdered form, into a line of pumped concrete, mortar, or plaster, etc. This can include any alkali metal accelerator, such as potassium carbonate, potassium silicate, or sodium hydroxide, should anyone want inclusion of any of these types of rapid-setting alkalis; though the present admixture does not require any alkali agent to be included for an extremely rapid set of Portland cement, as it constitutes a preferred alkali-free rapid accelerator.

Another advantage of the non-water-liquid admixture is that a water-reactive rapid-setting-cement accelerator can also be included as a solids component. This includes calcium sulfoaluminate-based (CSA) accelerators (such as are manufactured by the Denka Company Limited, Nihonbashi Mitsui Tower, 1-1, Nihonbashi-Muromachi 2-chome, Chuo-ku, Tokyo 103-8338, Japan), calcium aluminate-based (CA) accelerators (such as are manufactured by CALTRA Nederland BV, Communicatieweg 21, P.O. BOX 306, 3640 AH Mijdrecht, The Netherlands), and calcium sulfate-based (CS), which are effectively set-accelerators (such as are manufactured by the USG Corporation, 550 West Adams Street, Chicago, IL 60661-3676). These components are more reactive as accelerators when the material is as amorphous as possible, rather than crystalline. CA and CS accelerators can remain stable in the admixture for extended periods, such as for many months, whereas CSA accelerators generally appear to slowly react to thicken the admixture over days or sometimes longer. CSAs have no detrimental effect on the resulting concrete at most doses and for most environmental exposures, and in fact can be used by this method to improve the final strength of the concrete. CAs can have some long-term detrimental “conversion,” but this is not a real possibility at the typical low dose levels of the present admixture, and does not occur in interior environments. CS-based accelerators can weaken Portland cement by some interference with hydration hardening, but the typical dose here is not enough to make a significant difference.

These agents can be categorized as “mineral accelerators,” and this category of component has become more important to the admixture composition as it is applied in helping the 3D printing of cementitious mixes. This is ironic in that most thinking is that 3D printing differs from slip-forming because slip-forming requires an accelerator, where 3D printing requires a thickener (rheology modifier), because 3D printing is considered to be a faster build. The present inventor has found the opposite to be true, in developing very-rapid slip-forming methods that can use normal concrete, modified inline, where an extreme amount of thickening is beneficial—to allow vertical build rates such as a foot (30 cm) per minute. In contrast, contemporary 3D printing is very much slower, and usually does not require as much thickening, and this new admixture allows longer time for layering 3D print by holding moisture, allowing use of a cement retarder, and not requiring an accelerator to be involved in the concrete or mortar modification. A rapid vertical build (of unreinforced, narrow wythes) does require stability—that cannot easily be achieved without some setting of the cement. Also, as the print rate is slower than typical concrete placement is, there are issues with setting up of cement in the pump lines. A solution for this is to retard the cement beforehand, such as with citric acid or a proprietary retarding product such as Delvo, by Master Builder Solutions; then, the inline injection of admixture, which can include at least one set-accelerator, for purposes of offsetting the batched retarder, as necessary. So, for both reasons, a higher dose of an accelerator, such as one of these mineral accelerators, can be beneficial to the admixture.

Modified starches are most helpful in being inexpensive and very powerful thickeners that work primarily by water absorption and swelling. Such a starch should be cold water soluble and be of relatively small particle size, about 50 microns being preferred, or smaller if possible. Using such a starch allows a wetter concrete to be batched and the starch can thicken effectively to make it stand up, regardless. A starch product that is really dextrin can retard Portland cement too excessively. What has been learned in this testing, is that a starch can help stabilize the admixture by filling in for other thickeners (that can make the admixture unstable without the starch). However, starch can cause shrinkage to concrete, and the thickening effect can be too sudden and extreme-so that it can be a problem to get concrete out of the nozzle. The goal is to obtain the admixture stability benefit and an appropriate amount of thickening for the application at hand, but without the negative aspects. The present inventor has found that for very-rapid slip forming, the starch can be a highly-thickening version and at a proportion such that it can be the primary source of the initial solids-induced thickening, whereas for a 3D-printing admixture, the starch proportion (or thickening property) should be reduced. In any application, overthickening from starch generally should be avoided, because of risk of line blockages and possible concrete shrinkage effects; however, the stabilization effect is surprisingly beneficial to the admixture.

A primary starch utilized in these admixtures can be Modified Starch Gel 100001056, by Cargill, Incorporated, P.O. Box, 9300, Minneapolis, MN, 55440-9300, United States. Another is “TenderJel C,” a non-ionic starch made by Tate and Lyle, 5 Marble Arch, London, W1H 7EJ, United Kingdom. For 3D-printing applications, a less-thickening starch than these can also be appropriate. The thickening starch can be one that is modified, or modified and hydrolyzed. The retarding effect from a dextrin can sometimes be beneficial for interlayer bonding of 3D-print filaments, but this retarding effect can be too strong and so hurt vertical buildability.

The present inventor has found a cellulose ether thickener to clearly reduce concrete plastic shrinkage in a drying environment, even in contradiction to published literature. These shrinkage tests were made repeatedly, and in differing conditions. The most consistent shrinkage reducing solids component, for all the admixture compositions tested, is a cellulose ether. The mechanism for this exceptional reduction in plastic shrinkage appears to be the combination of cellulose ether with the admixture liquid, such as propylene carbonate, which provides an early gel strength, and because it is presoaked in the liquid solvent, which delays the swelling action of the cellulose ether. Also, the combination of these two components is very effective in reducing bleedwater evaporation. Accordingly, cellulose ether is a beneficial component and complements starch in it having a less-abrupt thickening effect on concrete. The problems with cellulose ether are: It makes concrete very sticky, it has a destabilizing influence on the admixture, and it is more likely than a modified starch to absorb atmospheric moisture over time, and so shorten the shelf life of the admixture. Also, it is not available (to my knowledge) in a preferably-small-enough particle size, with the version used being around 500 microns-making it the largest particle in the admixture. When versions have problems with solids collecting at choke points of an admixture pump line, then causing blockages, cellulose ether is almost always involved and often the only problem component in that regard. So, because of this problem, the lack of stability in admixture problem, and the stickiness issue, cellulose ether is typically a secondary thickener, but it makes the cut because of the very surprising shrinkage prevention, which is extremely beneficial.

The primary cellulose ether used is BERMOCOLL EBM 5500, a non-ionic, water soluble cellulose ether with enhanced enzyme resistance. It improves the consistency, the stability, and the water retention of water based products. It is made by Nouryon, Haaksbergweg 88, De Oliphant Building, Floor 14 and 15, 1101 BZ, Amsterdam, The Netherlands.

Similar cellulose-based thickeners such as methylcellulose, methyl ethyl hydroxyethyl cellulose, methyl hydroxyethyl cellulose, ethyl hydroxyethyl cellulose, methyl ethyl hydroxyethyl cellulose, carboxymethyl cellulose, sodium carboxymethyl cellulose, hydroxypropyl methylcellulose, et cetera, can all be delivered by this liquid admixture. Some of these can be retarding to Portland cement, so this factor should be taken into account.

Experiments have shown that inclusion of components that are an air detrainer, or defoamer, into the admixture, can be beneficial. This includes those such as tributyl phosphate or polydimethylsiloxane, acetaldehyde, propylene glycol, ethylene oxide, propylene oxide. To varying degrees, these will slow the absorption of moisture by the solids, thus lengthening the shelf life of the admixture. The dose for an air detrainer can be very low to serve this purpose, such as 0.5% of admixture, and it can be relatively high, such as 10%, where removal of air in the concrete mix is preferred. A low-viscosity defoamer, such as tributyl phosphate, can itself serve as the carrier liquid, but this would be unnecessarily expensive-unless a lower cost production method becomes available.

Traditional liquid accelerators for cement can be included in the admixture, though these in isolation tend to be too thick to serve as a liquid carrier. Some of the liquid amine accelerators, such as the triethanolamine, diethanolamine, and triisopropanolamine, that are also emulsifiers, so can serve the dual purpose of stabilizing an admixture composition and accelerating the set of cement. This dose should be as a minor component, as these have a higher viscosity and tend to be hygroscopic, and so can allow unwanted thickening of the admixture during storage; so access to atmospheric water vapor should be sealed off for storage.

Liquid metallic thiosulfates, such as calcium thiosulfate, and sodium thiosulfate, which provide a false set as sulfates do, can also provide advantage in being a low-viscosity liquid, and so these can also serve as the liquid carrier for the water-reactive solids in admixture formulations. Compatibility when used in combination with the other carrier liquids, and also for reaction with solids, needs to be checked, as some combinations will react within the admixture, causing unwanted thickening.

Other common solids accelerators such as lithium carbonate, aluminum sulfate, or calcium nitrate, that may not dissolve or suspend well in the liquid carrier, would need to be ground finer than usual, until the surface area is sufficient to allow suspension, such as possibly smaller than cement particles, if used in the admixture. The inclusion of other nano particles, such as fumed silica, will assist in the suspension of other mineral solids, such as the accelerators listed here.

The table below shows a few example admixture compositions for various purposes. The components listed can be substituted with others. These are some admixture variations found to be preferable for the present inventor; others will have their own opinions. These strongly-modifying admixtures are intended to be injected at a controlled dose rate, into a line of pumped concrete and intermixed with the inline mixer, previously disclosed by incorporation, though they can also be intermixed with concrete as a user may manage by other means.

These admixtures can vary considerably for the intended application, in that the non-water-liquid encapsulation of water-reactive solids provides an effective stealth delivery mechanism for strongly-reactive solids components. This allows a wide range of latitude in selection of those solids to suit applications. The 3D admixture is suitable for 3D printing, where an average vertical build rate is in the range of a few centimeters per minute, and material deposition is under about 50 liters per minute. It has more emphasis on setting the concrete to create stability. The SF admixture is for rapid slip forming, where the vertical build rate is in the range of 10 to 50 cm per minute, and the material deposition rate is not limited. It has a balance between thickening and set acceleration. The MAX admixture is intended for material deposition rates of over a few hundred liters per minute, and/or for a wetter concrete, where thickening is emphasized. MAX has the most dose sensitivity, 3D the least, and SF in between. The admixture dose is highly dependent upon, and very sensitive to, the w/c of the concrete, and particularly for very low w/c concrete having a HRWR. Admixture compositions D1, D2, D3, HOT, and ROMAN are discussed below, near or below the set and shrinkage graphs for some of these compositions. The relative proportions of any of these formulations can vary as noted in TABLE 1 which shows Rheology Modifying Admixture Compositions by Mass in units of percent by mass. The proportions of solids can go higher than the amounts listed, particularly if the materials have a very minimal moisture content. As the solids' moisture content goes up, the thickening effect in the non-water liquid increases, limiting the maximum practical proportion, which then could be lower than the amounts shown. High shear mixing is preferable or necessary in any case, and this will tend to lower admixture viscosity, particularly when a hydrophobic fumed silica is included.

TABLE 1

| | 3D | SF | MAX | D1 | D2 | D3 | HOT | ROMAN |
|---|---|---|---|---|---|---|---|---|
| | (%) | (%) | (%) | (%) | (%) | (%) | (%) | (%) |
| PC | 48.82 | 51.32 | 59.97 | 50.14 | 62.14 | 45.72 | 78.00 | 60.00 |
| FS | 1.35 | 2.01 | 3.64 | 1.22 | 1.52 | 1.12 | 22.00 | 4.00 |
| RM | 35.71 | 20.80 | 0.00 | 30.58 | 0.00 | 46.47 | 0.00 | 36.00 |
| MS | 5.24 | 12.48 | 36.39 | 8.04 | 22.49 | 2.76 | 0.00 | 0.00 |
| CE | 7.65 | 12.4 | 0.00 | 9.13 | 12.76 | 3.13 | 0.00 | 0.00 |
| DT | 1.24 | 0.90 | 0.00 | 0.88 | 1.09 | 0.81 | 0.00 | 0.00 |

PC indicates propylene carbonate, though the other carrier liquids listed above, or other organic solvents can function in this role; some adjustment to the listed proportions may be necessary to compensate for liquid viscosity or ability to absorb a given solid with more or less change in viscosity. PC is a favorable carrier liquid for the admixture in that it is non-toxic, and approved for long-term skin contact—as it is approved as a component in makeup. It is a non-VOC regulated solvent; there is very little loss to evaporation, and no odor. It is of relatively low cost, and it has no environmental issues. Also, it provides a strong gelling action to cement slurry, while having significant shear thinning, so helping with pumping and vibrating the concrete. After providing that initial gelling, it continues further, acting as a set accelerator-though it is a set than can be reversed with introduction of shear forces-allowing subsequent manipulation of concrete if necessary. Most of the non-water liquids of previous disclosures can also be used, and/or combined with PC, though hygroscopic action should be monitored, as this will cause water-reactive solids to thicken the admixture. The liquid carrier, termed “non-water” is really “essentially non-water”, as some water will nearly always be present, as an impurity in this case, because of the ever-present water vapor in our world. A goal is to keep the admixture water content low enough to prevent, or substantially delay, a reaction of the water-reactive solids.

And in using PC with fumed silica, there is no need to include oleo chemicals, stabilizers, surfactants, etc. In general, the PC is preferably utilized as much as practical to carry solids into the concrete, without increasing the viscosity beyond what is pumpable with equipment selected. When water-soluble thickeners are suspended in the admixture, they will tend to pick up atmospheric moisture over time, and then thicken the admixture too much. This is why it should be stored in a sealed container.

This use of PC reduces carbon release directly, in that the increasingly green production of PC converts CO2 directly into PC, and this new use of PC then sequesters that CO2 into concrete. As this use of PC requires significantly less cement and other binders for 3D printing or other additive manufacturing, saving significant CO2 release; and because this admixture allows use of normal concrete for these processes, in contrast to pre-packaged cementitious 3D-print mixes, requiring very high levels of cement and other expensive binders. Importantly, as the current typical practice is to ship the many tons of the entirety of materials to be printed (except water), whatever distance it is from manufacturing location to a given jobsite, the carbon emissions just from the shipping is appalling and wasteful. This can be avoided with just a low dose of the present admixture into native concrete materials. Often, claims will be made about other cementitious materials substituting for cement, to save that relative amount of CO2 emission, but this does not solve the problem, as presently there is a shortage of these materials from everyone wanting to do this. At this writing, the concrete supplier local to the present inventor, cannot obtain any supplementary cementitious materials, and all mixes go out with just cement as binder. So, the real solution is to optimize the amount of concrete used, and require less cement and binder for that concrete; both of these are accomplished by the present invention.

FS is fumed silica, as discussed. It can be omitted from any of these formulations or replaced with a surfactant, et cetera, but there will tend to be decreased functionality. The dose shown is for a hydrophobic type of fumed silica, with a BET surface area of 130 square meters per gram. The dose is affected by the type used; use more for a lower surface area, or use less for a higher surface area or if it is a hydrophilic fumed silica. RM indicates a reactive mineral: accelerator, or shrinkage compensator, or the like. This can be an amorphous calcium aluminate cement accelerator, such as Calumex SC-A, which can be considered a typical choice for the purposes of this table; or this can be a CSA or CS, as discussed above; or calcium oxide, discussed below. There are many other reactive minerals, or combinations of various reactive minerals that can be included. RM can be a clay, or a fibrillated or nano-clay, per previous disclosures. MS is a modified starch, as discussed. The proportions shown are based in a strongly-gelling starch. If a less-gelling variety is used, these amounts should increase, and there will be increased stabilization of the admixture, but potentially an unwanted retarding action on the portland cement. CE is a cellulose ether, in this case the EBM-5500, though it can be one or more of many other cellulose-based thickeners, such as those disclosed previously. AD is an optional air detrainer, which can be tributyl phosphate (TBP) or polydimethylsiloxane (PDMS), or the like. These are low doses, which are to help prevent the water-thickening solids from reacting with atmospheric moisture, lengthening the shelf life. TBP is commonly used to reduce air in concrete, and so can be very helpful in that some 3D-print mixes have too-high an air content, as viscosity modifiers, including many discussed herein, tend to increase concrete air content. Should reducing the air content be preferred, a greater proportion of TBP can replace more of the PC, though a greater proportion of PDMS may weaken the hardened concrete (probably not an issue). As these components tend to separate to the top of the admixture, inclusion of either will require more mixing before use.

The admixture dose is generally indicated to be proportional to the entire concrete (or entire cementitious mixture) volume, intermixed according to previous disclosures listed. This is because the amount of admixture does not necessarily change as the proportion of cement, and/or other binder, is increased or decreased. Also, this makes it more convenient to dose volumetrically as a proportional total material flow. Dose by mass, as determined by testing, needs to be adjusted for the density difference between admixture and concrete, to determine the volumetric proportion. The preferred dose is dependent on many factors, and can change many times over a concrete placement, according to variations in actual w/c, slump, mix design, temperature, use of retarder, problems in placement or consolidation, and vertical build rate requirement. The preferred dose, with respect to thickening, is tied mostly to actual w/c, not slump.

For example, if when testing with cement for 3D printing applications, a preferred admixture dose may be shown to be 0.4% of cement by mass (such as in tests at a 0.40 to 0.45 w/c). If the concrete is 18% cement by mass, then the equivalent admixture dose, relative to total concrete, would be about 0.07% of concrete by mass. If the particular admixture is half the density of the concrete, then this would be equal to 0.14% of total concrete volume, for example. For a cubic meter of concrete, this is about 1.4 liters. For a cubic yard, this would be about 0.31 gallons of admixture. This is a low dose, such as would be used for 3D printing applications. The dose could be lower; such as for a 0.30 to 0.35 w/c in hot weather, a dose of about 0.25 gallons per yard, or about one liter per cube, can be appropriate. At this lower dose, it is more possible that some concrete never makes contact with any admix because of imperfect intermixing. This is not a problem, in that this is simply some unmodified concrete included in the concrete placement.

In many cases it may be preferable to add a retarder to the batch of concrete, and also to not have such a low w/c, possibly because of warm weather conditions and/or a motivation to avoid blockages in the concrete pump line. This admixture volumetric dose would be higher, such as around 4 to 5 liters per cube, or a about gallon per yard. This would be a common dose rate.

If the admixture composition is less thickening, perhaps instead contains less of the thickeners (and possible more of reactive minerals: set accelerators and/or shrinkage compensators), and/or the concrete is too wet and/or the weather is cold, then the admixture dose could preferably be several times that amount, such as up to a dozen liters per cube, or a few gallons per yard of concrete. A dose this high has been required once in testing, when a concrete delivery showed up with far too much water for the necessary vertical build rate. As the present admixture can have no water, it avoids the “runaway” phenomena where no amount of an aqueous admixture can save a very wet concrete, because the increased amount of such a water-based admixture itself is adding yet more water to the concrete. For this case, this non-water admixture having a delivery-liquid that itself effectively thickens cement, will allow a very-high-slump concrete, even a self-consolidating (self-leveling) concrete, to be modified 3D printed or very-rapidly slip-formed.

Admixture composition HOT, dosed at very high proportion, such as even up to 10% of cement mass, is an unusually fast and novel set-accelerator. It can create a hard set of ordinary portland cement within one minute, where a very small batch can generate an exothermic temperature exceeding 57° C. in a 15° C. environment. As neither the propylene carbonate nor the fumed silica individually can cause this effect, it appears that it is caused by their unique combination, in that a high proportion of fumed silica, soaked in propylene carbonate, serve as nucleation seeds for initiation of rapid hydration, in being combined with the accelerating carbonates released from the high dose of propylene carbonate.

This admixture composition and inline injection idea can be used for purpose other than thickening or rheology modification; such as only for the delivery of water-reactive shrinkage-compensating solids, to avoid the problems and stress relating to the extremely fast permanent set, common to these products; or for production of “Roman” concrete, discussed below. In other words, when these water-reactive products are introduced into water or concrete, there is then only a very short time available after intermixing them, where the concrete must then be placed. The process can end in disaster when encountering even the slightest delay. By use of this idea of suspending these water-reactive solids in a non-water liquid-carrier, so the shrinkage-compensators can be ready to be injected into concrete anytime, and intermixed upon demand, within a pump line, the process can be so much easier. Another example is to use this process for inline delivery of retarder-compensating admixtures, of which the liquid carrier itself can be, for concrete previously batched with a corresponding retarding agent.

Calcium oxide (quicklime) has been found to be a very beneficial accelerator in terms of providing an elevated hydration temperature combined with additional calcium oxide. This combination changes portland cement hydration chemistry (particularly when including a pozzolan such as fly ash, or if only a pozzolanic binder) to create “lime clasts”, which improve concrete durability-more so than with use of only additional less-reactive hydrated lime (calcium hydroxide). The lime clasts are shown to be superior (than results of using hydrated lime) in subsequently reacting with water entering cracks, creating calcium carbonate to seal the cracks, and protect the concrete. Recent research has concluded that this is the secret to “Roman concrete”. The process and its chemistry is presented in the publication Science Advances, 6 Jan. 2023, Vol 9, Issue 1; authored by: Linda M. Seymour, Janille Maragh, Paolo Sabatini, Michel Di Tommaso, James C. Weaver, and Admir Masic.

Introducing the extremely water-reactive calcium oxide powder into a concrete mix has the same logistical problems present with other water-reactive components, in that the modified cement is now set-accelerated and must be placed within a very short time before it sets, making placement the process unforgiving, or impractical, for larger placements. So, this novel concept of a non-water liquid carrier for cement modification, also allows inclusion of calcium oxide suspended the carrier liquid, for this beneficial purpose, allowing the calcium oxide inclusion to be a practical and easy process, preferably with use of an inline mixer, previously disclosed by the present inventor. For example, this type of admixture could be simply calcium oxide suspended in most any non-water shrinkage compensator (disclosed above), such as tripropylene glycol methyl ether or propylene carbonate, to a concentration that allows pumping of the admixture. This can be a proportion of calcium oxide, or other water-reactive powder, from zero up to 40% the liquid carrier by mass. Some nano-particle fumed silica or the like, per disclosure above, can be included to help with keeping the reactive powder in suspension, and if hydrophobic, will lower the admixture viscosity, allowing the concentration of water-reactive powder to be higher.

The admixture version ROMAN is where the RM is calcium oxide. This admixture can benefit from an optional amount of FS, which can be up to 10%, both for improving lubricity, providing cement hydration nucleation seeds, and also in providing some pozzolanic effect for more beneficial reaction with the calcium oxide. This is an example of where two mutually-reacting components remain inert and unreactive to each other in a liquid form, suspended in a non-water liquid. When the non-water liquid is effectively replaced with water upon intermixing with a concrete mixture, they then react. A high dose of ROMAN admixture reacts similarly to HOT, in that portland cement can be made to set within a minute. Of course, it can be dosed lower, such as at 1% of concrete, and provide the longevity benefits of the Roman concrete.

The admixture provides significant other benefits to conventional concrete practices, is allowing earlier removal of forms, and a faster buildup of shotcrete-particularly on overhead surfaces.

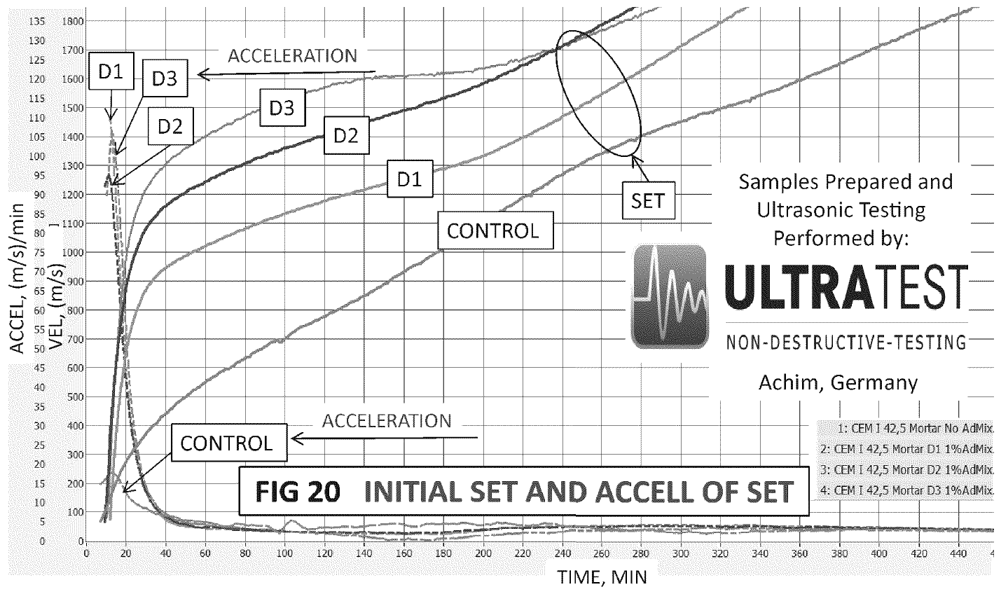

### FIG. 20

FIG. 20 is a graph of an ultrasonic measurement of relative cement apparent set and relative acceleration of apparent set. This testing was performed by UltraTest GmbH, Am Schmiedeberg 6, 28832 Achim, Germany, an ultrasonic measuring equipment manufacturer. The rate of ultrasound wave travel is proportional to the solidification of cementitious materials, referred to as “set”, though in the present case it is apparent set, as the admixture provides a rapid set, but one that is reversible, and that set is what is measured here. The extreme difference that a 1% dose (by mass of entire mix) of 3 variations (D1, D2, D3) of admixture provide to an ordinary portland-cement-based mortar mix is extreme, where the acceleration of cement set at 12 minutes in, is increased by over 500%; and the amount of set at 30 minutes in is increased by up to 350%. This shows the almost unbelievable amount of change in set that can be provided by this admixture concept.

Another novel benefit of this admixture is that this set is “apparent” in that, because of the extreme shear thinning, it can be vibrated out-even when seemingly a relatively hard set. Though unlike a false set, this apparent set repeats, indefinitely. That is, although the set is hard enough to allow a vertical build up of even one story high, intense local vibrating action can allow a reworking of that area, which will then re-set.

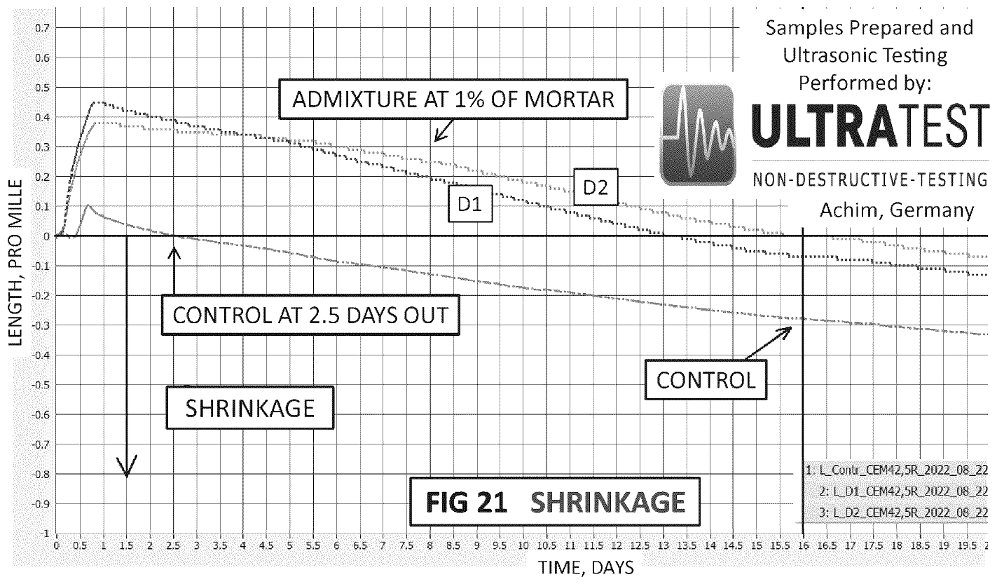

### FIG. 21

FIG. 21 shows the effect of shrinkage, measured by strain, in proportion by thousandths, of 2 versions of the admixture at 1% of total mortar mix by mass, compared to a control mortar, under controlled-humidity conditions. It is apparent that both versions of the 1% admixture dose causes expansion initially, which compensates subsequent shrinkage, reduces net shrinkage, and significantly delays net shrinkage, from 2.5 days, to 13.5 to 16 days. The effect of this delay allows a change in sequence in the cement curing process, where any included fibers can sufficiently develop their bond to cement before net shrinkage occurs, thereby significantly increasing the benefit of fibers for crack prevention, and significantly reducing shrinkage problems, and the need for other shrinkage mitigation measures—such as control joints, or more frequent control joints. Also, in testing of immediate plastic shrinkage in drying conditions, with and without the admixture, shows a surprisingly remarkable difference, where plastic shrinkage cracking—that can consistently occur at exposed surfaces of thin placements pf Portland-cement-based concrete or mortar (such as 3D printing)—can be prevented 100%, by a dose of 1% (or less) of the admixture.

The preferred dose with respect to shrinkage reduction (such as 1% of total mixture by mass) can be larger than that needed for necessary rheology modification (such as 0.25%); so counterintuitively, a mix design for minimizing shrinkage would actually have a greater proportion of water, such as a w/b of 0.45, in order to be able to accept a higher dose of admixture (than otherwise can be dosed to a lower w/b without over-thickening). This effect can be maximized by utilizing an admixture composition having less starch or a less-thickening starch.

Long term shrinkage reduction can be achieved with this admixture in combination with fibers in the concrete, to a significantly greater effect than use of the same fibers without the admixture. The reason for this is the initial reduction of early shrinkage, both plastic shrinkage and drying shrinkage, by preventing evaporation of water during curing, and in providing reduced capillary forces, the well-known physics of SRAs, and inclusion of any shrinkage compensator. When fibers are included, additionally, the admixture allows development of fiber bond to occur much sooner. This early bonding accentuates and amplifies the benefit of fibers. The admixture changes the sequence of concrete strength development, where, because of the admixture, both strength gain is accelerated and shrinkage is delayed, so that strength gain now precedes shrinkage, to where the fibers can develop sufficient bond before shrinkage begins to load them in tension. This effect has been phenomenal, where in a 40-foot (13M) length, with no control joints, where the modified concrete was left to dry out in sun and wind, shows no visible cracking. PVA fibers used were included at 1.5 pounds per yard (0.9 Kg per Cubic Meter).

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed:

1. A method for constructing a wall, the method comprising:
placing a plane of insulation (1);
applying a layer of cladding (2) on a side of the plane of insulation (1),
forming a concrete wall structure (3) on an opposite side of the plane of insulation (1) by in situ placing a cementitious material against the plane of insulation (1); and
placing a wall tie (7) through the plane of insulation (1) to attach the layer of cladding (2) to the concrete wall structure (3) so that one end of wall tie (7) is cast into the layer of cladding (2) and the other end of wall tie (7) is cast into the concrete wall structure (3).

2. The method of claim 1, wherein the layer of cladding (2) is a cementitious material.

3. The method of claim 1, wherein the plane of insulation (1) comprises foam and the placing the plane of insulation (1) is accomplished by forming the foam in place to create the plane of insulation (1).

4. The method of claim 1, further comprising placing reinforcing bars (10) so that the reinforcing bars (10) are cast in the concrete wall structure (3).

5. The method of claim 1, further comprising placing a reinforcing mesh (8), vapor permeable waterproofing layer (9), waterproofing layer (11), or combinations thereof to form the wall.

6. The method of claim 1, wherein the cementitious material is placed by an additive layering process.

7. The method of claim 1, wherein the cementitious material is placed using a slip forming process.

8. The method of claim 1, wherein the cementitious material is placed using a 3D printing process.

9. The method of claim 1, wherein the cementitious material is placed using an extrusion process.

10. The method of claim 1, further comprising placing a frame having an open area so as to define an opening in the wall.

11. The method of claim 1, further comprising using machine control to place a frame so that the frame defines an outer surface of the cementitious material.

12. The method of claim 1, further comprising using machine control to place a frame so that the frame defines an outer surface of the cementitious material, the frame comprises one or more electronic identification devices for frame location.

13. The method of claim 1, further comprising using machine control to place a frame so that the frame defines an outer surface of the cementitious material, the frame contains one or more electronic identification devices for guidance of cementitious material placement.

14. The method of claim 1, wherein the placing a plane of insulation (1), the applying a layer of cladding (2) on a side of the plane of insulation (1), the forming a concrete wall structure (3) on an opposite side of the plane of insulation (1) by in situ placing a cementitious material against the plane of insulation (1) are performed contemporaneously.

15. The method of claim 1, wherein the placing a plane of insulation (1), the applying a layer of cladding (2) on a side of the plane of insulation (1), the forming a concrete wall structure (3) on an opposite side of the plane of insulation (1) by in situ placing a cementitious material against the plane of insulation (1) are performed simultaneously.

16. The method of claim 1, wherein the plane of insulation (1) comprises foam and the placing the plane of insulation (1) is accomplished by forming the foam in place to create the plane of insulation (1) and the foam is an expanding urethane foam.

17. The method of claim 1, wherein the plane of insulation (1) comprises foam and the placing the plane of insulation (1) is accomplished by forming the foam from a polymeric isocyanate and a resin in place to create the plane of insulation (1).

18. The method of claim 1, wherein the plane of insulation (1) comprises foam and the placing the plane of insulation (1) is accomplished by forming the foam as a freestanding plane.

19. The method of claim 1, wherein the plane of insulation (1) comprises foam and the placing the plane of insulation (1) is accomplished by forming the foam as a freestanding plane from a two-part expanding foam into a freestanding, flat plane of insulation.

20. The method of claim 1, wherein the forming a concrete wall structure (3) comprises providing an admixture to a cementitious mixture to form the cementitious material.

21. The method of claim 1, wherein the forming a concrete wall structure (3) comprises providing an admixture to a cementitious mixture to form the cementitious material, the admixture comprises one or more of water-reactive solids material, suspended in a non-water liquid carrier.

22. The method of claim 1, wherein the forming a concrete wall structure (3) comprises providing an admixture to a cementitious mixture to form the cementitious material, the admixture comprises one or more of water-reactive solids material, suspended in a non-water liquid carrier comprising glycols, glycol ethers, dialkyl ethers, glycol esters, propylene glycol, polypropylene glycols, dipropylene glycol, polyethylene glycol, ethyl formate, glycerol, di or tripropylene glycol methyl ether, di or tripropylene glycol normal butyl ether, propylene carbonate, diethylene glycol butyl ether, tetraethylene glycol, or combinations thereof.

23. The method of claim 1, wherein the forming a concrete wall structure (3) comprises providing an admixture to a cementitious mixture to form the cementitious material, the admixture comprises one or more of water-reactive solids material comprising cellulose based water-reactive solids, starch based water-reactive solids, clay based water-reactive solids, calcium oxide, a cement accelerator, a thickening agent, a rheology modifying agent, or combinations thereof, suspended in a non-water liquid carrier.

24. The method of claim 1, wherein the forming a concrete wall structure (3) comprises providing an admixture to a cementitious mixture to form the cementitious material, the admixture comprises one or more of water-reactive solids material comprising cellulose based water-reactive solids, starch based water-reactive solids, clay based water-reactive solids, calcium oxide, a cement accelerator, a thickening agent, a rheology modifying agent, or combinations thereof, suspended in a non-water liquid carrier comprising glycols, glycol ethers, dialkyl ethers, glycol esters, propylene glycol, polypropylene glycols, dipropylene glycol, polyethylene glycol, ethyl formate, glycerol, di or tripropylene glycol methyl ether, di or tripropylene glycol normal butyl ether, propylene carbonate, diethylene glycol butyl ether, tetraethylene glycol, or combinations thereof.

25. A system to form a wall, the system comprising: a foam-former (4), a vertical placement system (5), and a concrete placement system (6); the foam-former (4), the vertical placement system (5), and the concrete placement system (6) being disposed together to be operated in proximity so that the foam-former (4) forms foam panels at the location for the wall so that the vertical placement system (5) applies a layer of cladding (2) on a side of the foam panels, and the concrete placement system (6) forms a concrete wall structure (3) on an opposite side of the foam panels by in situ placing a cementitious material against the foam panels.

26. The system of claim 25, wherein the foam-former (4) comprises a foam slip forming device.

27. The system of claim 25, wherein the foam-former (4) comprises a foam slip forming device that implants wall tie elements (7) in the wall.

28. The system of claim 25, wherein the foam-former (4) comprises a foam slip-forming device with a foam pusher.

29. The system of claim 25, wherein the foam-former (4) comprises one or more plates (18, 19) having a non-stick surface (30) forming a confined space to define a shape for the foam.

30. The system of claim 25, wherein the foam-former (4) comprises one or more plates (18, 19) having a non-stick surface (30) forming a confined space to define a shape for the foam, the non-stick surface (30) comprises a hydrogel film surface.

31. The system of claim 25, wherein the foam-former (4) comprises one or more plates (18, 19) having a non-stick surface (30) forming a confined space to define a shape for the foam, the non-stick surface (30) comprises a hydrogel film surface of a crosslinked hydrophilic polymer that does not dissolve in water.

32. The system of claim 25, wherein the foam-former (4) comprises one or more plates (18, 19) having a non-stick surface (30) forming a confined space to define a shape for the foam, the non-stick surface (30) comprises a hydrogel film surface of a crosslinked hydrophilic polymer that dissolves slowly in water.

33. The system of claim 25, wherein the foam-former (4) comprises one or more plates (18, 19) having a non-stick surface (30) forming a confined space to define a shape for the foam, the non-stick surface (30) comprises a hydrogel film surface of a multiple-network hydrogel.

34. The system of claim 25, wherein the foam-former (4) comprises one or more plates (18, 19) having a non-stick surface (30) forming a confined space to define a shape for the foam, the non-stick surface (30) comprises a hydrogel film surface of an acrylamide polymer hydrogel.

35. The system of claim 25, wherein the foam-former (4) comprises one or more plates (18, 19) having a non-stick surface (30) forming a confined space to define a shape for the foam, the non-stick surface (30) comprises a hydrogel film surface impregnated with a cross-linked cellulose nanofiber network.

36. The system of claim 25, wherein the foam-former (4) comprises one or more plates (18, 19) having a non-stick surface (30) forming a confined space to define a shape for the foam, a fluid control system to control the fluids for forming the foam, and to control a flow of water to the non-stick surface (30).

37. The system of claim 25, wherein the foam-former (4) comprises one or more plates (18, 19) having a non-stick surface (30) forming a confined space to define a shape for the foam, a fluid control system to control the fluids for forming the foam, and to control a flow of water to the non-stick surface (30), the non-stick surface (30) comprising a hydrogel film surface.

38. The system of claim 25, wherein the foam-former (4) comprises at least one mobile robot, a motion control system to guide the at least one mobile robot, and a fluid control system to control the fluids, the motion control system and fluid control system being connected so that fluid for forming the foam can be supplied and the foam-former (4) can be moved by the at least one mobile robot so foam shaped as adjacent panels can be formed for the wall.

39. The system of claim 25, wherein the vertical placement system (5) comprises a vertical-axis control system with a wall brace mechanism.

40. The system of claim 25, wherein the vertical placement system (5) comprises an extruder to extrude the layer of cladding.

41. The system of claim 25, wherein the concrete placement system (6) comprises an extruder to extrude the cementitious material.

42. An admixture that modifies a cementitious material to provide a change in rheology of the cementitious material, the admixture comprising one or more water-reactive solids, suspended in a non-water liquid carrier, the water-reactive solids being reactive with water in the cementitious material to change the rheology of the cementitious material.

43. The admixture of claim 42, wherein the water-reactive solids comprise cellulose based water-reactive solids.

44. The admixture of claim 42, wherein the water-reactive solids comprise starch based water-reactive solids.

45. The admixture of claim 42, wherein the water-reactive solids comprise clay based water-reactive solids.

46. The admixture of claim 42, wherein the water-reactive solids comprise calcium oxide.

47. The admixture of claim 42, wherein the water-reactive solids comprise a cement accelerator.

48. The admixture of claim 42, wherein the water-reactive solids comprise a thickening agent.

49. The admixture of claim 42, wherein the water-reactive solids comprise a rheology modifying agent.

50. The admixture of claim 42, wherein the water-reactive solids comprise a shrinkage compensating agent.

51. The admixture of claim 42, wherein the water-reactive solids comprise a shrinkage reducing agent.

52. The admixture of claim 42, wherein the water-reactive solids comprise nanoparticles.

53. The admixture of claim 42, wherein the water-reactive solids comprise nanoparticles that act as seeds for cement hydration nucleation.

54. The admixture of claim 42, further comprising nanoparticles that stabilize the suspension of the water reactive solids.

55. The admixture of claim 42, further comprising nanoparticles of fumed silica.

56. The admixture of claim 42, wherein the non-water liquid carrier comprises a shrinkage reduction agent.

57. The admixture of claim 42, wherein the non-water liquid carrier comprises an organic solvent.

58. The admixture of claim 42, wherein the non-water liquid carrier comprises a thiosulfate.

59. The admixture of claim 42, wherein the non-water liquid carrier comprises a rheology modifier.

60. The admixture of claim 42, wherein the non-water liquid carrier comprises propylene glycol.

61. The admixture of claim 42, wherein the non-water liquid carrier comprises polyethylene glycol.

62. The admixture of claim 42, wherein the non-water liquid carrier comprises propylene carbonate.

63. The admixture of claim 42, wherein the non-water liquid carrier comprises an ether.

64. The admixture of claim 42, wherein the non-water liquid carrier comprises an alcohol.

65. The admixture of claim 42, wherein the non-water liquid carrier comprises glycerol.

66. The admixture of claim 42, wherein the non-water liquid carrier comprises glycols, glycol ethers, dialkyl ethers, glycol esters, propylene glycol, polypropylene glycols, dipropylene glycol, polyethylene glycol, ethyl formate, glycerol, di or tripropylene glycol methyl ether, di or tripropylene glycol normal butyl ether, propylene carbonate, diethylene glycol butyl ether, tetraethylene glycol, or combinations thereof.

67. An apparatus for slip forming an active adhesive, the apparatus comprising: a substantially rigid plate, a hydrogel film surface supported by the rigid plate, a connection to a source of water to wet the hydrogel film.

68. The apparatus of claim 67, wherein the hydrogel film surface is bonded to the rigid plate.

69. The apparatus of claim 67, wherein the hydrogel film surface is a crosslinked hydrophilic polymer that does not dissolve in water.

70. The apparatus of claim 67, wherein the hydrogel film surface is a crosslinked hydrophilic polymer that dissolves slowly in water.

71. The apparatus of claim 67, wherein the hydrogel film surface is of a multiple-network hydrogel.

72. The apparatus of claim 67, wherein the hydrogel film surface is of an acrylamide polymer hydrogel.

73. The apparatus of claim 67, wherein the hydrogel film surface is impregnated with a cross-linked cellulose nanofiber network.
